(19) United States
(12) Patent Application Publication
(10) Pub. No.: US 2026/0329650 A1
(43) Pub. Date: Oct. 22, 2026

(54) TECHNIQUES FOR COMPARATIVE INDEX ANALYSIS

(71) Applicant: GARRISON OLSON LLC, Chicago, IL (US)

(72) Inventor: Ryan Garrison, Chicago, IL (US)

(21) Appl. No.: 19/689,232

(22) Filed: May 27, 2026

Related U.S. Application Data
(63) Continuation-in-part of application No. 19/523,419, filed on Oct. 8, 2025.
(60) Provisional application No. 63/704,913, filed on Oct. 8, 2024.
(60) Provisional application No. 63/711,122, filed on Oct. 23, 2024.

(51) Int. Cl. G06F 9/50; G06F 16/22; G06F 16/28

(52) U.S. Cl. CPC G06F 9/5027; G06F 16/22; G06F 16/285

(57) ABSTRACT

Techniques for comparative index analysis are disclosed herein. An example method includes obtaining a first set of index data from a first data source indicating preference values within a defined decision context and a second set of index data from a second data source indicating action values within the same decision context; validating structural alignment between the data sources; grouping attributes with items based on defined tagging rules at a stock-keeping unit level; allocating action values across multiple attributes; determining a first index value based on preference values, a second index value based on allocated action values, and a third index value representing a discrepancy between stated user preferences and observed user actions; optionally determining a saturation value representing attribute exposure across a supercategory and/or classifying attributes into opportunity states based on the index values and saturation value; and causing the index values to be displayed on a user interface.

### CROSS-REFERENCE TO RELATED APPLICATIONS

This application is a continuation-in-part of U.S. Nonprovisional patent application Ser. No. 19/523,419, entitled “Techniques for Comparative Index Analysis,” filed on Mar. 26, 2026, which is a U.S. national stage of International Application No. PCT/US2025/049963, filed on Oct. 8, 2025, which claims priority to U.S. Provisional Patent Application No. 63/711,122, entitled “Techniques for Comparative Index Analysis,” filed on Oct. 23, 2024, and claims priority to U.S. Provisional Patent Application No. 63/704,913, entitled “Techniques for Comparative Index Analysis,” filed on Oct. 8, 2024, the disclosures of each of which are hereby incorporated herein by reference.

### FIELD OF THE INVENTION

The present techniques relate to data analytics, and more particularly, to comparative index analysis for quantifying and interpreting discrepancies between user preferences and user actions, such as performing a motivation/action analysis.

### BACKGROUND

A notable challenge in data analytics is the integration and comprehensive analysis of individual preferences with individual actions. Many typical methodologies treat these data streams as separate/independent entities, but this separation fails to provide a holistic view of individual actions and leads to discrepancies between the individual's motivation and their actions. These conventional techniques struggle to quantify and leverage these discrepancies effectively and accurately, resulting in a significant lack of actionable insights.

For example, many common techniques struggle to provide outputs that capture the rapidly changing motivations/actions of multiple, distinct cohorts (e.g., groups of individuals of different ages, socio-economic statuses, genders, etc.) of individuals accurately and reliably. The data sets often associated with these tasks are vast (e.g., tens, hundreds of thousands of inputs for each motivation and action) and difficult to parse through to yield meaningful insights, as different individuals generally interpret the relative importance of their motivations differently. Moreover, different cohorts frequently have fundamentally different influencing factors (e.g., total expendable income) that can change over time and skew the input/output data, thereby creating inaccurate comparisons across these cohorts. Common techniques also generally fail to predict future motivation/action indexes for new cohorts/individuals or otherwise update their strategies to account for them.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 depicts an example environment in which systems/methods for comparative index analysis may be implemented, in accordance with embodiments described herein.

FIG. 2 depicts a first example scenario in which an index algorithm iteratively outputs updated answers and/or recommendations in response to receiving input data at distinct time instances, in accordance with various embodiments described herein.

FIG. 3 depicts a second example scenario in which an index algorithm receives a plurality of input data to generate a plurality of output answers and/or recommendations, in accordance with various embodiments described herein.

FIG. 4 is a flowchart representative of a method for comparative index analysis, in accordance with embodiments described herein.

FIG. 5 is a flowchart of an example method for comparative index analysis involving data validation and processing, in accordance with embodiments described herein.

FIG. 6 is a block diagram of a hierarchical analysis framework for comparative index analysis, in accordance with embodiments described herein.

FIG. 7 is a flowchart of an example method for opportunity-state classification and routing, in accordance with embodiments described herein.

FIG. 8A is a flowchart of an example method for constructing a composite index, in accordance with embodiments described herein.

FIG. 8B is a flowchart of an example saturation method for calculating behavior-weighted attribute exposure, in accordance with embodiments described herein.

FIG. 9 is a flowchart of an example method for validating attribute-level inputs prior to downstream computation, in accordance with embodiments described herein.

FIG. 10 is a flowchart of an example method for comparative index analysis involving decision context validation and attribute-based indexing, in accordance with embodiments described herein.

FIG. 11 is a flowchart of an example method for comparative index analysis incorporating saturation values and opportunity state classification, in accordance with embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The complexity and evolving nature of individual behavior, particularly in the context of their stated preferences, indicates a need for more nuanced approaches when attempting to understand discrepancies between the individual's motivation and their actions. These discrepancies have significant implications for entities across various industries. The techniques described herein provide a sophisticated approach to quantify, interpret, and leverage this gap for actionable insights and changes/adjustments through the application of a comparative index analysis system.

The techniques described herein process and analyze data through a series of indices derived from, for example, survey/panel data and sets of purchase data. The systems described herein may calculate these indices using various combinations of linear regression analysis, normalization, weighting techniques, among others, to accurately reflect the preferences and actions of different individual cohorts. By employing machine learning algorithms, the systems described herein can isolate and extrapolate driving factors behind individual decisions, predict future individual actions (e.g., purchase decisions), provide recommendations and/or draft examples of product changes, marketing plans, merchandizing and assortment plans, and/or other recommendations.

The systems described herein are capable of concurrently evaluating multiple variables and their interactions through regression analysis. This not only provides a more comprehensive understanding of how various factors influence the discrepancies between an individual's motivation and their actions (and/or other similar phenomena) but also enables the systems described herein to interpret and leverage the relative impact and importance of these factors. In particular, the coefficients obtained as part of the regression model indicate the direction and magnitude of each factor's (e.g., survey question) impact on these discrepancies, thus enabling the system to identify over-indexing and under-indexing variables. This analysis enables the system to determine recommendations, draft examples of the recommendations, and/or answers to user queries based on the variables/factors that are most likely to minimize these discrepancies (e.g., yield closer alignment between individual stated preferences and individual actions) in a meaningful way (e.g., overall magnitude of impact, rate of change in gap closure, etc.). Thus, the systems described herein can more effectively and accurately recommend product/service developments/changes/adjustments over time in response to individual preferences and actions than was conventionally possible, resulting in improved products and services.

These advantages are further compounded by the system's use of AI and machine learning as a continuous feedback loop for entities that monitors emerging discrepancies, tracks the progress of prior recommendations/implementations, and continually updates its recommendations/predictions in response to updated input data and/or user queries. Such an automated, query-able system provides flexible, nuanced recommendations/predictions resulting in measurable improvements to the field of data analytics through the consistent reduction/minimization of discrepancies between individual motivations and actions. The systems described herein intake a consistent, vast stream of data (e.g., tens, hundreds of thousands of individual preferences and actions), and provide detailed, accurate insights that the system further leverages for real-time adjustments and strategic recommendations to, e.g., products and services, among others.

More specifically, the present techniques represent an improvement to data processing capabilities of such large quantities of data. The specific formulation of the composite indices and the application of ML techniques described herein enable the computing systems described herein to efficiently process large datasets (e.g., tens, hundreds of thousands of inputs across multiple themes/categories) to provide actionable insights. Conventional techniques lack such an efficient analytical framework, resulting in this analysis typically being performed on a significantly smaller scale and/or over a significantly longer period. As a result, conventional techniques frequently yield either substantially less accurate/reliable results and/or excess consumption/demand on available processing resources.

Further, the present techniques represent a significant improvement to the field of data analytics through the improved accuracy of the present techniques in comparison to conventional techniques. The techniques of the present disclosure may normalize and/or weight received input data and/or outputs based on certain predicted characteristics/qualities of the cohort of interest, ensuring more accurate comparisons across different cohorts than was previously achievable. Moreover, by employing linear regression analysis and various ML techniques, the present techniques not only identify motivations that contribute most significantly to individual motivation/action discrepancies but also predict future motivation/action indexes for new cohorts/individuals, along with recommendations to proactively anticipate and accommodate their needs. Furthermore, utilizing ML techniques to iteratively refine the motivation/action indices over time represents an advancement in the adaptive learning capabilities of computing systems in the field of data analytics. As new data is received, the systems described herein can dynamically adjust weightings, normalization factors, and/or otherwise update/re-train the ML models to ensure that the output predictions/recommendations remain relevant and accurate.

Existing comparative index analysis techniques also face persistent computational challenges when integrating preference data from survey sources with action data from purchase panel sources. These data sources are inherently heterogeneous, as they are generated by different collection methodologies, stored in different formats, and frequently reference different decision contexts, such as different categories, time periods, or population baselines. When a computing system processes these heterogeneous data sources without first verifying structural alignment, the system computes index values using mismatched population denominators, incompatible category boundaries, and/or non-overlapping temporal windows. The resulting index values appear facially valid (e.g., they are numerical outputs within expected ranges) but are mathematically incomparable because the preference-based index and the action-based index reference different underlying populations or contexts. Consequently, any downstream analysis reliant on these mismatched index values, including gap calculations, composite constructions, regression validations, and monetization estimates, propagate the structural error through the entire processing pipeline Such erroneous result propagation consumes significant computational resources to generate outputs that lack analytical meaning. In other words, the underlying computing systems analyzing this data naively process it as thought it were homogeneous, as such systems lack indicators to perform any such analysis differently. Moreover, because the outputs appear numerically plausible, existing systems lack the ability to detect or flag these structural failures, resulting in the system continuing to allocate processing resources to downstream operations that compound rather than correct the underlying data integrity failure.

The present techniques address these computational challenges by introducing a structured governance architecture that validates structural alignment between heterogeneous data sources before permitting downstream computation. Specifically, the present systems obtain a first set of index data from a first data source indicating preference values within a first defined decision context (e.g., comprising a category, a time period, and a population baseline) and a second set of index data from a second data source indicating action values within a second defined decision context, and validate that the first defined decision context is the same as the second defined decision context. If the defined decision contexts are not the same, the system rejects or flags the calculation as structurally invalid and halts the processing pipeline. In doing so, these techniques prevent the processors from expending computational resources on downstream index calculations, composite constructions, and/or monetization estimates that would be rendered meaningless by the mismatched input data. This validation step thus changes the underlying computing device's operation to perform/not perform subsequent analysis based on the decision context, and thereby operates as a computational gate that directly controls computing resource allocation/utilization. Namely, the validation performed by the present techniques conditions subsequent processing on verified structural alignment, ensuring that the processing resources consumed by downstream operations produce outputs that are mathematically comparable and analytically valid.

Building upon this structural validity layer, the present techniques further address challenges associated with mapping survey-derived attributes to observable product-level behavior. Connecting stated preferences to actual purchases is generally challenging because attributes referenced in surveys may not correspond to identifiable product features in panel data, and products frequently carry multiple attributes that can lead to overrepresentation when aggregating action values. The present systems overcome these challenges by grouping each of the plurality of attributes with one or more items based on defined tagging rules including on-pack claims, ingredient composition, or item descriptions, wherein each item is identified at a stock-keeping unit (SKU) level, and excluding any attribute for which fewer than a threshold number of items in the category are identifiable as carrying the attribute. The present systems further allocate, for each item associated with a plurality of attributes, an action value associated with the item across the plurality of attributes such that a total of allocated action values across all attributes does not exceed a total category action value, thereby preventing double counting and ensuring that attribute-level spend reconciles to total category behavior.

In certain embodiments, the defined tagging rules may utilize data from a variety of sources, such as on-pack claims, ingredient composition, product descriptions, nutrition facts, certification data, product metadata, retailer data, manufacturer data, product catalogs, product images, optical character recognition (OCR) or image recognition systems, text classification systems, machine-classified attributes, public data sources, licensed data sources, first-party data, third-party data, automatically collected product-level information, and/or proprietary product databases. The attribute mapping layer is generally source-agnostic, such that the system may operate across different data environments including syndicated data, retailer feeds, manufacturer feeds, licensed datasets, public product information, proprietary data, and/or automatically collected product-level information. This source-agnostic design ensures that the system is not dependent on any single data supplier or implementation model, and the system may thus be deployed across diverse retail, e-commerce, and omnichannel environments.

The present techniques also incorporate market saturation analysis to contextualize and classify the nature of preference-action discrepancies. Interpreting a positive gap between stated preferences and observed behavior is generally challenging because such a gap could indicate different underlying conditions depending on supply dynamics. To address this challenge, the present systems determine, for each attribute, a saturation value representing at least an attribute exposure across a supercategory, wherein the saturation value is derived from action values associated with items carrying the attribute. The present systems then classify each attribute into an opportunity state based on a combination of the first index value, the second index value, the third index value, and the saturation value, and select a processing path from a plurality of different processing paths, wherein each processing path generates a different type of output for the attribute.

In certain embodiments, the system may maintain tagging governance metadata associated with each attribute-to-item mapping. This metadata may include tag source identifiers, tag confidence scores, tag versions, tagging rule identifiers, mapping criteria, review statuses, and/or audit metadata, among others. If an attribute cannot be reliably mapped to items based on the defined tagging rules, the system may flag the attribute, down-weight the attribute, suppress the attribute from downstream calculations, route the attribute to a separate review processing path, and/or exclude the attribute from index calculations until the mapping is resolved. Consequently, the present systems leverage this tagging governance layer to maintain data integrity across heterogeneous data sources while providing transparency into the provenance and reliability of attribute mappings.

In certain embodiments, the present systems apply rule-based classification to determine opportunity states, wherein an innovation opportunity is classified when the first index value exceeds a first threshold, the second index value is below a second threshold, and the saturation value is below a third threshold, a friction opportunity is classified when the first index value exceeds the first threshold, the second index value is below the second threshold, and the saturation value exceeds the third threshold, and an overinvestment signal is classified when the first index value is below the first threshold, the second index value exceeds the second threshold, and the saturation value exceeds the third threshold. The present systems further generate recommendations based on the opportunity state, wherein the recommendation differs based on whether the opportunity state is an innovation opportunity, a friction opportunity, or an overinvestment signal. Consequently, these techniques route attributes through distinct analytical pathways that produce targeted outputs rather than undifferentiated gap metrics.

It should be appreciated that the saturation value described herein is distinct from generic SKU-count saturation metrics that merely measure the percentage of products carrying a particular attribute. Simple SKU-count saturation (e.g., “20% of products in the category carry the organic attribute”) does not account for the actual market presence or consumer-facing exposure of those products. The present techniques integrate the saturation value into the Say-Do architecture to contextualize, rank, flag, route, or otherwise modify interpretation of the Say-Do Gap. In doing so, the present techniques transform a raw market-presence metric into a signal that informs downstream computation and recommendation generation. In particular, the integration of saturation with the governed Say-Do pipeline allows the present systems to perform opportunity-state classification and differential processing path selection based on the combination of stated preferences, observed behavior, and market supply dynamics, which existing techniques are unable to do.

Further, the saturation value may be determined using any of a variety of weighting approaches, such as observed-action weighting, spend-weighting, unit-weighting, volume-weighting, market-footprint weighting, distribution-based weighting, velocity-based weighting, or economic normalization. The saturation value may be based on item-level presence, claim prevalence, product-count prevalence, distribution breadth, availability metrics, shelf presence, search visibility, promotional exposure, retail-media exposure, spend share, unit share, volume share, velocity metrics, market share, household penetration, repeat rate, purchase frequency, brand concentration, manufacturer concentration, private-label concentration, retailer concentration, and/or combinations thereof. Regardless of the specific calculation methodology, the saturation value is generally determined within the same decision context as the first index value and the second index value. Thus, the saturation value may generally contextualize the third index value rather than introducing misaligned market signals from a different category, time period, and/or population baseline. The saturation value also thus operates as an additive contextual layer within the Say-Do architecture, providing market supply context that informs interpretation of the preference-action discrepancy without replacing the core Say Index, Do Index, or Say-Do Gap calculations.

In certain embodiments, the present systems construct composite indices using governed weighting structures that maintain distinct treatment of preference-based and action-based measurements. The present systems determine a composite first index value as an equal-weight average of the first index values across a set of attributes, and determine a composite second index value as a weighted sum of the second index values across the set of attributes, wherein each weight is based on a total population action value for the respective attribute relative to a sum of total population action values across all attributes in the set. Further, these systems determine whether any weight exceeds a maximum threshold, and in response to determining that a weight exceeds the maximum threshold, cap the weight at the maximum threshold and renormalize the weights such that the weights sum to one. This generally prevents the composite second index value from becoming computationally dependent on a single attribute, which may otherwise cause the composite to mechanically track the dominant attribute's behavior and render the multi-attribute aggregation functionally redundant.

When a single attribute dominates the composite without capping, all downstream computations that depend on the composite, including gap calculations, opportunity state classifications, and monetization estimates, are effectively driven by a single attribute's data rather than the intended multi-attribute signal. This may cause the system to select incorrect processing paths during opportunity classification and to generate recommendations that do not account for emerging attributes. Moreover, during iterative recomputation with updated input data, an uncapped dominant weight amplifies variance from that single attribute, causing disproportionate fluctuations in the composite that reduce the stability and reliability of outputs across successive computation cycles. These computational integrity issues are compounded at scale. When the system processes data across tens or hundreds of thousands of items, each carrying one or more attributes, an uncapped dominant weight causes the system to allocate significant processing resources to computing composite values, gap calculations, opportunity classifications, and monetization estimates that are mechanically driven by a single attribute's data, effectively replicating the single-attribute computation across the entire multi-attribute pipeline for each of the one or more subsets of users without producing meaningfully differentiated outputs. The capping and renormalization mechanism thus reduces unnecessary consumption of processing resources by ensuring that the composite computation produces a genuinely multi-attribute signal at each stage of the pipeline, rather than propagating a single-attribute dependency through every downstream operation across the full volume of ingested data.

Overall, the specific processing architecture, predictive capabilities, and dynamic prediction adjustments enable the present techniques to provide reliable, accurate predictions/recommendations to adjust, change, and/or otherwise modify products, services, and/or factors (e.g., marketing materials, pricing strategies) in a manner that was simply unachievable using conventional techniques.

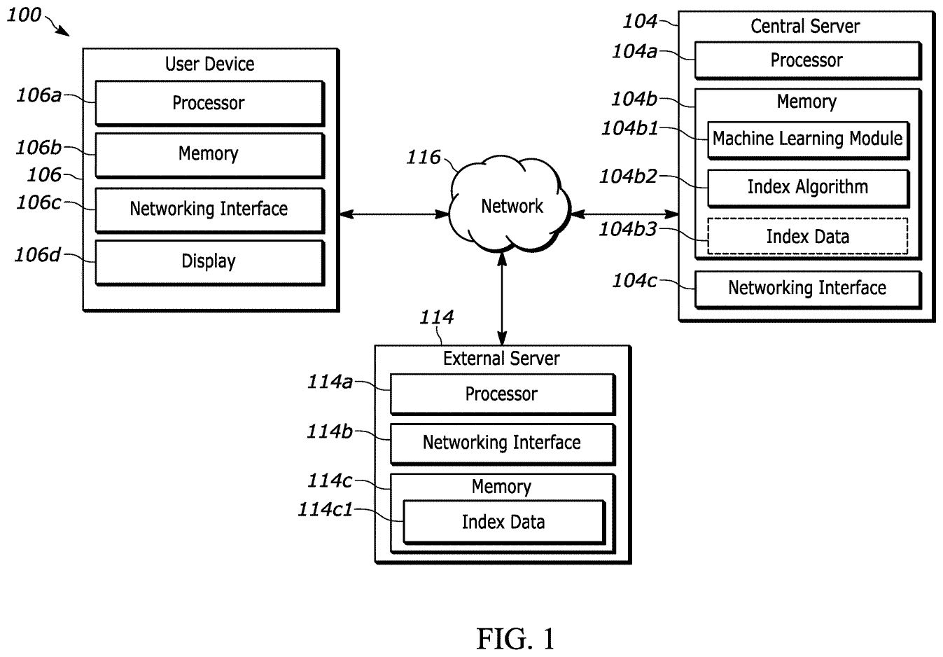

Turning to the Figures, FIG. 1 depicts an exemplary computing system 100 in which various embodiments of the present disclosure may be implemented. Depending on the embodiment, the exemplary computing system 100 may generate a first index value associated with preference values of one or more users, a second index value associated with action values of one or more users, a third index value associated with the preference values and the action values of one or more users, and/or any other values or combinations thereof. Of course, it should be appreciated that, while the various components of the exemplary computing system 100 (e.g., user device 106, external server 114, etc.) are illustrated in FIG. 1 as single components, the exemplary computing system 100 may include multiple (e.g., dozens, hundreds, thousands) of each of the components that are simultaneously connected to the network 116 at any given time.

Generally speaking, the exemplary computing system 100 may include a central server 104, a user device 106, and an external server 114. The central server 104 may generally receive data from a user device 106 and/or the external server 114 connected to the network 116 and may process the data in accordance with one or more sets of instructions contained in the memory 104b to output any of the values/responses described herein. The central server 104 may include one or more processors 104a, one or more memories 104b, and a networking interface 104c. The memory 104b may include various sets of executable instructions that are configured to analyze data received at the central server 104 and analyze that data to output various values. These executable instructions include, for example, a machine learning module 104b1, an index algorithm 104b2, and a set of index data 104b3. The memory 104b may also store additional data and/or databases.

For example, the data the central server 104 receives may be or include index data corresponding to one or more users/individuals. The index data may generally correspond to user preferences and/or actions associated with one or more items, such as services, consumer goods, and/or other items or combinations thereof. As referenced herein, the user/individual “preferences” included as part of the index data may generally reference the user/individual's stated preferences with respect to a particular topic(s)/concept(s), and the user/individual “actions” may generally reference the user/individual's actual behavior (e.g., purchases) with respect to the particular topic(s)/concept(s). The one or more users/individuals may be grouped into sets and/or subsets (also referenced herein as “cohorts”), and the central server 104 may calculate (e.g., by the index algorithm 104b2) index values for one or more of the users, sets, and/or subsets/cohorts. The central server 104 may also calculate and/or otherwise determine one or more composite values that correspond to many/most/all users represented in the index data.

The central server 104 may further calculate index values based on one or more of the calculated index values. For example, the central server 104 may calculate (e.g., by the index algorithm 104b2) a first index value may correspond to a preference value of a first cohort of users compared to a composite preference value for all users represented in the index data, and a second index value may correspond to an action value of the first cohort of users compared to a composite action value for all users represented in the index data. In this example, the central server 104 may further apply the index algorithm 104b2 to the first and second index values to determine a third index value that generally indicates a tendency or propensity of the first cohort of users to act in accordance with their stated preferences.

In certain embodiments, the index algorithm 104b2 is an artificial intelligence (AI) trained algorithm/model that is configured to receive index data associated with one or more users and output one or more indices representing one or more characteristics of the one or more users. In particular, the index algorithm 104b2 may utilize any initial outputs (e.g., a first index value associated with preference values, a second index value associated with action values, etc.) to generate subsequent outputs (e.g., a third index value associated with both preference and action values, a fourth index value, etc.) that are transmitted and displayed/conveyed to the user through the user device 106. As a general example, when a user accesses the central server 104 (e.g., via network 116), the user's input data (e.g., index data) may be analyzed by the index algorithm 104b2 to generate outputs, such as index values.

In some embodiments, the central server 104 may include index data 104b3 that may include sets of index data comprising various index values associated with multiple users. The central server 104 may receive a set of index data from the user device 106 (and/or the external server 114), and this set of index data may include index data corresponding to a particular user, set of users, subset/cohort of users, etc. The central server 104 may then access/retrieve the corresponding index data from the index data 104b3 to update and actively re-evaluate any suitable index values for the user, set of users, subset/cohort of users based on the received set of index data. Moreover, the central server 104 may automatically instruct the machine learning module 104b1 and/or the index algorithm 104b2 to generate relevant index values and/or to train/re-train the index algorithm 104b2 to generate relevant index values in accordance with the index data 104b3 upon receipt of the set of index data from the user device 106 and/or the external server 114.

The index algorithm 104b2 may also group items together based on one or more characteristics of the items. For example, a first item may be a consumer good that is used to clean surfaces (e.g., tabletops, counters, etc.), and this consumer good may include a listing of ingredients. The index algorithm 104b2 may automatically interpret each ingredient in the listing, determine categorizations for some/many/all of the ingredients, and correspondingly determine a categorization for the consumer good (surface cleaner). If the surface cleaner has multiple ingredients that the index algorithm 104b42 determines to be “non-environmentally friendly”, then the index algorithm 104b2 may categorize the surface cleaner as non-environmentally friendly. If not, then the index algorithm 104b2 may categorize the surface cleaner as environmentally friendly. The index algorithm 104b2 may perform a similar categorization for the surface cleaner for multiple different categorizations simultaneously to determine a plurality of categorizations for the surface cleaner. More generally, each item may receive one or more categorizations associated with multiple categories. For example, the index algorithm 104b2 may determine categorizations for each item based on environmental sustainability, animal welfare, organic status, regenerative agriculture, packaging, vegan/plant based, high protein, functional foods, natural, gluten-free, and/or any other suitable criteria that may apply to a particular item.

With these categorizations, the index algorithm 104b2 may analyze the actions taken by users, sets of users, subsets/cohorts of users, etc. to determine how the stated preferences of these users compare to their taken actions. For example, the index algorithm 104b2 may analyze the purchasing habits of younger users (e.g., 18-24 years of age) along with the stated preferences of these younger users to determine how many of this cohort of users purchase items that align with their stated preferences. Of course, the index data 104b3, 114cl may include data corresponding with any suitable information of the associated users.

For example, the index data 104b3, 114cl may include data indicating each user's income, marriage status, age of the head of household, family/household size, rural/urban residence location, race, ethnicity, and/or any other suitable data or combinations thereof. Moreover, the cohorts themselves may be defined and/or otherwise described in terms of any of the data included as part of the index data 104b3, 114cl and/or any other data described herein or combinations thereof. For example, a first cohort may be individuals located in a Southeast region of the United States, and a second cohort may be individuals located in a Northwest region of the United States. As another example, a first cohort of individuals may be single/non-married individuals, and a second cohort may be married individuals. As yet another example, a first cohort may be individuals that have a household income of over $50,000 per year and that live in an urban environment, a second cohort may be individuals that have a household income of over $50,000 per year and that live in a rural environment, a third cohort may be individuals that have a household income of under $50,000 per year and that live in an urban environment, and a fourth cohort may be individuals that have a household income of under $50,000 per year and that live in a rural environment.

More generally, the index data 104b3, 114c1 may be or include stated preference values (e.g., indications of individuals' stated preferences regarding certain topics or concepts) and action values (e.g., indications of individuals' actions (purchases) regarding those certain topics/concepts). For example, the index data 104b3, 114c1 may indicate that a cohort of individuals (e.g., 18-24 year old individuals) have a strong stated preference for environmentally friendly packaging but they do not over-index relative to purchasing products (when compared to the total population) that utilize environmentally friendly packaging. As another example, the index data 104b3, 114c1 may indicate that a cohort of individuals (e.g., 35-45 year old individuals) have a weak/indifferent stated preference for animal friendly products but they over index relative to purchasing such products.

In some embodiments, the central server 104 may store and execute instructions that may generally train the index algorithm 104b2 stored in the memory 104b. For example, the central server 104 may execute instructions included as part of the machine learning module 104b1 that are configured to train the index algorithm 104b2 to output one or more index values and/or any other values or combinations thereof. In particular, the training dataset(s) may include a plurality of training index data as inputs and/or any other suitable data and combinations thereof. However, in certain embodiments, the index algorithm 104b2 may be a rules-based algorithm configured to receive sets of index data as input and to output index values and/or other indexes as output.

In some embodiments, the index algorithm 104b2 may be configured to utilize artificial intelligence and/or machine learning techniques. The index algorithm 104b2 may employ supervised or unsupervised machine learning techniques, which may be followed or used in conjunction with reinforced or reinforcement learning techniques. The index algorithm 104b2 may generate audible or verbal output, text or textual output, visual or graphical output, output for use with speakers and/or display screens, and/or other types of output for user and/or other computer or bot consumption.

Noted above, in some embodiments, the index algorithm 104b2 or other computing device may be configured to implement machine learning, such that the central server 104 “learns” to analyze, organize, and/or process data without being explicitly programmed. Machine learning may be implemented through machine learning methods and algorithms. In one exemplary embodiment, a machine learning module may be configured to implement machine learning methods and algorithms.

In some embodiments, at least one of a plurality of machine learning methods and algorithms may be applied, which may include but are not limited to: linear or logistic regression, instance-based algorithms, regularization algorithms, decision trees, Bayesian networks, naïve Bayes algorithms, cluster analysis, association rule learning, neural networks (e.g., convolutional neural networks, deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of a plurality of categorizations of machine learning, such as supervised learning, unsupervised learning, and reinforcement learning.

In one embodiment, the index algorithm 104b2 employs supervised learning, which involves identifying patterns in existing data to make predictions about subsequently received data. Specifically, the index algorithm 104b2 may be “trained” using training data, which includes example inputs and associated example outputs. Based upon the training data, the index algorithm 104b2 may generate a predictive function which maps outputs to inputs and may utilize the predictive function to generate machine learning outputs based upon data inputs. The exemplary inputs and exemplary outputs of the training data may include any of the data inputs or machine learning outputs described above. In the exemplary embodiment, a processing element may be trained by providing it with a large sample of data with known characteristics or features.

In another embodiment, the index algorithm 104b2 may employ unsupervised learning, which involves finding meaningful relationships in unorganized data. Unlike supervised learning, unsupervised learning does not involve user-initiated training based upon example inputs with associated outputs. Rather, in unsupervised learning, the index algorithm 104b2 may organize unlabeled data according to a relationship determined by at least one machine learning method/algorithm employed by the index algorithm 104b2. Unorganized data may include any combination of data inputs and/or machine learning outputs as described above.

In yet another embodiment, the index algorithm 104b2 may employ reinforcement learning, which involves optimizing outputs based upon feedback from a reward signal. Specifically, the index algorithm 104b2 may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

After training, machine learning programs (or information generated by such machine learning programs) may be used to evaluate additional data. Such data may be and/or may be related to index data, user device data, and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset. Such trained machine learning programs may, therefore, be used to perform part or all of the analytical functions of the methods described elsewhere herein.

It is to be understood that supervised machine learning and/or unsupervised machine learning may also comprise retraining, relearning, or otherwise updating models with new, or different, information, which may include information received, ingested, generated, or otherwise used over time. Further, it should be appreciated that, as previously mentioned, the index algorithm 104b2 may be used to output index values and/or any other values or combinations thereof using artificial intelligence (e.g., a machine learning model of the index algorithm 104b2) or, in alternative aspects, without using artificial intelligence.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

In any event, the central server 104 may execute the index algorithm 104b2 to generate one or more index values based on the set of index data (e.g., retrieved/accessed from the index data 104b3, 114c1 and/or received from user device 106), and the server 104 may then transmit the one or more index values to the user device 106 for display to a user. The user may then review the one or more index values and/or other values included as part of the analysis (e.g., composite values, subset/cohort specific index values) from the index algorithm 104b2.

Generally, the user device 106 may be or include any device that is associated with (e.g., configured to connect with, etc.) a particular user, who may connect to and/or otherwise provide data (e.g., index data) that may be transmitted to the central server 104 through the network 116. In certain embodiments, the user device 106 may be a personal computing device of that user, such as a smartphone, a tablet, smart glasses, or any other suitable device or combination of devices (e.g., a smart watch plus a smartphone) with wireless communication capability. In the embodiment of FIG. 1, the user device 106 may include a processor 106a, a memory 106b, a networking interface 106c, and a display 106d.

The user device 106 may be communicatively coupled to the central server 104 and/or the external server 114. For example, the user device 106 and the central server 104 and/or the external server 114 may communicate via USB, Bluetooth, Wi-Fi Direct, Near Field Communication (NFC), etc. For example, the central server 104 may transmit an index value and/or a set of index values across a communication channel of the computing system 100, and/or any other values or combinations thereof to the user device 106 via the networking interface 104c, which the user device 106 may receive via the networking interface 106c.

The external server 114 may be or include computing servers and/or combinations of multiple servers storing data that may be accessed/retrieved by the central server 104 and/or the user device 106. The data stored by the external server 114 may include index data 114cl that the index algorithm 104b2 may retrieve and/or otherwise access to perform the analysis described herein. For example, the external server 114 may be a data repository for the central server 104 administrator, and may store the index data 114cl received at the central server 104 before, during, or after processing via the index algorithm 104b2 to maintain a database of all index data over time. The external server 114 may include a processor 114a, a networking interface 114b, and a memory 114c that includes the machine learning chatbot 114c1.

Each of the processors 104a, 106a, and 114a may include any suitable number of processors and/or processor types. For example, the processors 104a, 106a, and 114a may include one or more CPUs and one or more graphics processing units (GPUs). Generally, each of the processors 104a, 106a, and 114a may be configured to execute software instructions stored in each of the corresponding memories 104b, 106b, and 114c. The memories 104b, 106b, and 114c may include one or more persistent memories (e.g., a hard drive and/or solid state memory) and may store one or more applications, modules, and/or models, such as the machine learning module 104b1 and/or the index algorithm 104b2.

The networking interface 104c may enable the central server 104 to communicate with the user device 106, the external server 114, and/or any other suitable devices or combinations thereof. More specifically, the networking interface 104c enables the central server 104 to communicate with each component of the exemplary computing system 100 across the network 116 through their respective networking interfaces 106c and 114b. The networking interface 104c may support wired or wireless communications, such as USB, Bluetooth, Wi-Fi Direct, Near Field Communication (NFC), etc. The networking interface 104c may enable the central server 104 to communicate with the various components of the exemplary computing system 100 via a wireless communication network such as a fifth-, fourth-, or third-generation cellular network (5G, 4G, or 3G, respectively), a Wi-Fi network (802.11 standards), a WiMAX network, a wide area network (WAN), a local area network (LAN), etc.

Moreover, the network 116 may be a single communication network, or may include multiple communication networks of one or more types (e.g., one or more wired and/or wireless personal or local area networks (PANs or LANs), and/or one or more wide area networks (WANs) such as the Internet). In some embodiments, the network 116 includes multiple, entirely distinct networks (e.g., one or more networks for communications between the central server 104 and the user device 106, and a separate, Bluetooth or wireless LAN (WLAN) network for communications between the central server 104 and the external server 114, and so on).

It will be understood that the above disclosure is one example and does not necessarily describe every possible embodiment. As such, it will be further understood that alternate embodiments may include fewer, alternate, and/or additional steps or elements.

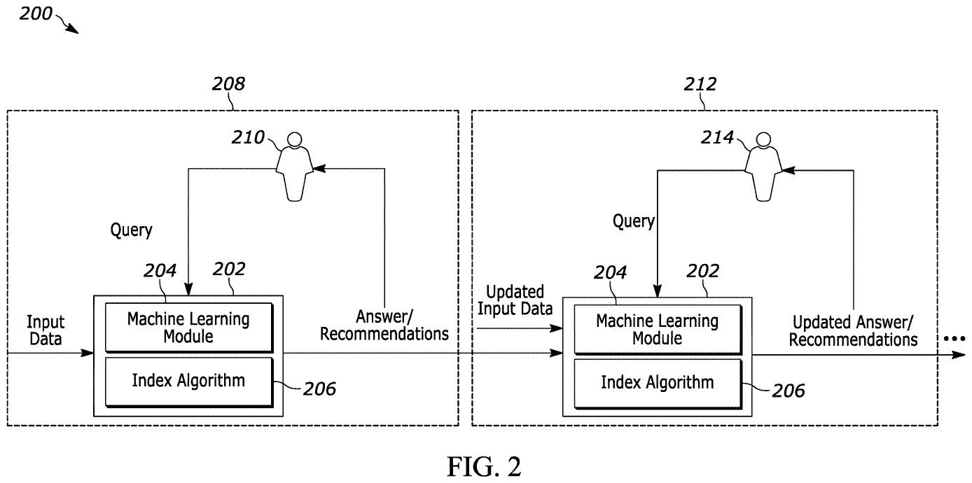

FIG. 2 depicts a first example scenario 200 in which an index algorithm 206 iteratively outputs updated answers and/or recommendations in response to receiving input data at distinct time instances, in accordance with various embodiments described herein. Generally, the first example scenario 200 illustrates a combination 202 of a machine learning module 204 and the index algorithm 206 receiving input data (e.g., individual responses to surveys, individual action data, user queries, etc.) and outputting answers, recommendations, and/or predictions corresponding to the input data. This first example scenario 200 further illustrates the combination 202 performing these operations at multiple, distinct time instances 208, 212, such that at the second time instance 212, the combination 202 generates updated answers, recommendations, and/or predictions based on the updated input data and the prior outputs. Thus, the first example scenario 200 illustrates the combination 202 iteratively providing outputs over time that can account for changing input data (e.g., index data 104b3, 114c1).

At the first time instance 208, the combination 202 receives input data, which may generally include index data, as described herein. The combination 202 may further receive a user query from a user 210, which may include a specific query related to the received input data. For example, the user query may request or indicate a request for one or more most influential factors (e.g., preferences/actions) on a resulting composite index value. In response, the combination 202 may generate one or more composite index values and may determine preference and/or action values that have a magnitude and/or a direction (e.g., positive, negative) that satisfy a corresponding threshold value.

For example, assume that a particular index value/sub-value (e.g., differential) for a first preference value and corresponding action value has a magnitude of ten and a negative direction, and every other index value/sub-value has a magnitude of one and a positive direction. The combination 202 may analyze this set of index values/sub-values, and may determine that the differential between the first preference value and corresponding action value satisfy a magnitude threshold (e.g., greater than or equal to five) and a direction threshold (e.g., positive, negative, one of fewer than three having a positive/negative direction). Accordingly, the combination 202 may determine that the index value/sub-value corresponding to the first preference value and the corresponding action value is a threshold value/sub-value and may return this index value/sub-value to the user 210 as part of a generated response.

At the second time instance 212, the combination 202 receives updated input data, which may generally include updated index data and the prior input data, and may receive the prior answers, recommendations, and/or predictions. The combination 202 may further receive a user query from a user 214, which may include a specific query related to the updated input data and/or the prior answers, recommendations, and/or predictions. For example, the user query may request or indicate a request for a summary of changes resulting from the implementation of the prior answers, recommendations, and/or predictions, as well as predicted actions to leverage the changes most advantageously. In response, the combination 202 may generate one or more composite index values, compare the composite index values to one or more of the prior composite index values, and generate one or more predictions/recommendations based on the current and prior composite index values, and the prior answers, recommendations, and/or predictions.

For example, assume that the prior set of input data (e.g., at the first time instance 208) indicates a particular cohort (e.g., single individuals) has a substantial gap between purchasing organic food items their strong stated preferences for such organic food items. At the first time instance 208, the combination 200 may output a recommendation for several packaging and marketing adjustments that are optimally configured to target and incentivize organic food item purchases within the particular cohort. At the second time instance 212, the updated input data may reflect a significant increase in organic food item purchases for the particular cohort. Thus, the combination 202 may analyze the updated input data, any portion of the input data (e.g., from the first time instance 208) that is not included in the updated input data, and the prior recommendation from the first time instance 208 to generate an updated recommendation/prediction associated with the particular cohort. In particular, the combination 202 may determine that the prior recommendation was successful in incentivizing the particular cohort to purchase organic food items, and the updated recommendation/prediction may indicate what is likely to be effective in motivating/incentivizing the particular cohort and one or more specific adjustments to the product packaging, pricing/marketing strategies, and/or other aspects of the product or corresponding media associated with the product to leverage these motivational concepts.

Overall, the combination 202 may generate any suitable number of answers, recommendations, and/or predictions at any suitable number of time instances to provide relevant, continuous guidance regarding a particular product/service. In particular, the combination 202 may receive a first user query at a first time instance (e.g., first time instance 208) corresponding to the first set of index data and the second set of index data, and determine the third index value based on the first user query, the first index value, and the second index value. These sets of index data (first and second) may include preference and action data, respectively, associated with one or more cohort(s) of interest (e.g., 18-25 year olds, 70+ year olds). Thereafter, the combination 202 may receive a second user query at a second time instance (e.g., second time instance 212) that is different from the first time instance 208, and the second user query may corresponding to a third set of index data and a fourth set of index data. These new sets of index data (third and fourth) may include updated preference and action data, respectively, associated with the one or more cohort(s) of interest that were featured in the first user query. The combination 202 may then determine a sixth index value based on (i) the first user query, (ii) the second user query, (iii) a first index value, (iv) a second index value, (v) a fourth index value, (vi) a fifth index value, and/or (vii) a third index value. The combination 202 may determine the third index value based on the first index value and the second index value, and the sixth index value may represent an updated third index value. In other words, the sixth index value may represent an updated motivation/action differential that reflects differences in motivations/actions of the cohort(s) of interest between the first time instance (represented by the third index value) and the second time instance (represented by the sixth index value).

The combination 202 may further generate a predicted outcome based on the sixth index value and/or the third index value and cause the predicted outcome to be displayed on the user interface. As an example, the predicted outcome may indicate that, at a second time instance (e.g., 212), a first cohort of interest has decreased their purchasing of a particular category of products despite their stated motivation remaining high since a first time instance (e.g., 208). Consequently, the combination 202 may include as part of the predicted outcome that the pricing strategy for this particular category of products should be adjusted (e.g., reduced) by $X to increase the overall sales to this particularly important first cohort. The combination 202 may then cause this predicted outcome to be displayed to the entity (e.g., at a user workstation or mobile device interface) for further analysis.

Thus, as illustrated in FIG. 2, the combination 202 may iteratively receive updates to input data and/or queries from users at any suitable time instance to generate answers, recommendations, and/or predictions related to any product, service, and/or other objects which individuals' preferences and/or actions are indicated. To determine these answers, recommendations, and/or predictions, the combination 202 and/or other components described herein may utilize specific formulations configured to highlight particular areas of interest.

Namely, the input data (e.g., index data) may include various responses of individuals of various cohorts related to one or more claims/attributes (referenced herein as “themes”). These themes may include various concepts, by way of example and without limitation, such as “better for me”, “better for the environment”, “better for society”, “better for animals”, “indulgence”, and/or other suitable themes or combinations thereof. The responses included in the input data may indicate individual stated preferences (e.g., on a scale of 1-5, 1-10, etc.) corresponding to questions related to these themes. Each of these questions may generally relate to one or more specific aspects of the overarching survey theme, such as claims or attributes relating to “Sustainability”, “Organic Foods/Products”, “Packaging”, “Vegan/Plant Based”, “Protein”, “Functional Foods”, “Natural”, “Non-Processed”, “Human-Grade”, “Heritage”, “Gluten-Free”, “Ingredient Combinations”, “Recycled”, “Compostable”, “Renewable”, “Sugar-Free”, “Artificial Sweeteners” and/or any other suitable topic(s) or combinations thereof. For example, questions related to “Sustainability” may correspond to, e.g., the “better for society” and the “better for the environment” themes of a particular survey. The answers to these questions related to the particular theme(s) of the panel survey, as represented by the index data, may have direct implications for various industry categories including, for example and without limitation, consumer packaged goods (CPG), retail environments, ingredient suppliers, and/or technology and durables products or combinations thereof.

In general, any panel of questions may include responses (e.g., comprising index data) indicative of a single cohort, but it should be appreciated that the index data input into the combination 202 at any time instance (e.g., 208, 212) may include index data associated with multiple cohorts. In this manner, and as discussed herein, the techniques of the present disclosure can provide highly granular details regarding the motivation/action discrepancies for each individual cohort based on the question-by-question evaluation of such discrepancies for each cohort across themes and/or categories. By evaluating specific cohort behaviors in isolation (e.g., individually), the systems described herein (e.g., the combination 202) can further leverage these insights to compare how different cohorts behave across themes/categories and to identify/predict emerging trends within individual cohorts and/or combinations of cohorts across such themes/categories.

In certain embodiments, the combination 202 may receive a user query prompting the combination 202 to generate a series of questions (e.g., a survey/panel) related to a particular theme and/or category, and the combination 202 may leverage prior surveys/panels, retrieve relevant information from private/public resources (e.g., a retrieval-augmented generation (RAG) model), and/or otherwise generate a new series of questions to be sent to members of one or more cohorts. In these embodiments, the index algorithm 206 and/or the machine learning module 204 may include and/or otherwise access a large language model (LLM) to analyze the received input data and generate contextually relevant questions.

As an example, the combination 202 may receive input data and/or a user query prompting the combination 202 to evaluate the index values for “Better for the environment” claims. Thus, the input data may include responses to questions and purchase data for all represented cohorts that are related to the “Better for the environment” claims. For example, a panel associated with the “Better for the environment” claims may include questions like, “How important is eco-friendly packaging when you purchase grocery products from a retailer?” and “Do you actively seek products with regenerative agriculture listed as a claim?”

The combination 202 may provide individuals with a range of prioritization in the survey to enable individuals to indicate their respective priorities. For example, the range may be from one through five with five being the highest driver of motivation for purchase and one being not influential at all. More specifically, one may indicate that the specific concept/motivation is not important at all, two may indicate that the specific concept/motivation is minimally important, three may indicate that the specific concept/motivation is somewhat important, four may indicate that the specific concept/motivation is important, five may indicate that the specific concept/motivation is very important to the individual. The combination 202 may then find the average responses where households report each of these claims/attributes as being “important” or “very important” (e.g., four and five responses), the percentage of which the combination 202 uses as a baseline for deviation for individual cohorts. In certain embodiments, the combination 202 may calculate each average household response on a question-by-question basis, and the combination 202 may utilize this average household response as the foundation of the composite indices described herein.

The combination 202 may then create a composite index, in part, by analyzing the relative importance of each response relative to purchase actions. The combination 202 may also give each claim/attribute a weighting based on the relative importance (e.g., on the five-point scale) of each response to a particular entity. The combination 202 may generate a first index value based on respective preference values and composite preference values, and more specifically, the combination 202 may generate the first index value as a percentage of respondents in each cohort who report the attribute/claim as important divided by the average percentage of households.

For example, the combination 202 may determine that average households report “How important is eco-friendly packaging when you purchase grocery products from a retailer?” as “Important” or “Very important” 70% of the time, and that average households report “Do you actively seek products with regenerative agriculture listed as a claim?” 65% of the time. The combination 202 can then examine the variations between what average households report for each and what a specific demo/cohort reports based on this two-question composite index. Further, assume that the combination 202 examines responses from 18-25 year olds (when asking the same two questions), and their responses to the respective questions are 85% and 70% of the time. In this example, the combination 202 may determine a first (composite) index value of:

(85/70)+(70/65)/2=(1.214+1.077)/2*100=114.56 (1),

where, the first index value (unweighted) is approximately 114 for 18-25 year olds who claim “Better for the environment” attributes motivate purchase.

Continuing the above example, if an entity querying the combination 202 to perform the index analysis chooses to weight the variables surveyed in the panel, they could include such weightings or prioritizations in a query as input to the combination 202. For instance, if the entity is particularly interested in packaging (at a 20% prioritization), an example of the weighting may be:

((85/70)*1.2)+(70/65))/(1+1.2)=((1.214×1.2)+1.077)/2.2*100=115.8 (2),

where the weighted first index is 115.8.

The combination 202 may then calculate a second (composite) index value by, for example, examining household purchase “panel” data, where “panel purchase” data is data coded to connect to a panel. Following through with the above example to match the questions to purchase data, the combination 202 may calculate the average household spend for “Eco-Friendly Packaging” purchases and “Regenerative Agriculture Products”. For the purposes of illustration only, assume that these values are $223 and $182, respectively. The combination 202 may then determine the 18-25 year old spend in each of those question categories falling under the “Better for the environment” grouping/theme used in the example thus far. Further, assume that the average 18-25 year old household spends $160 on “Eco-Friendly Packaging”-related products and $120 on “Regenerative Agriculture Products” respectively. The combination 202 may then calculate the second index value by:

((160/223)+(120/182))/2×100=68.84 (3),

where the second index value for the cohort of 18-24 year olds is approximately 68, indicating an average 18-24 year old household spend of approximately $68 on “Better for the environment” products. Similar to the first index value, the combination 202 may weight and/or determine weights for each of these values.

The combination 202 may then determine a third (composite) index value by subtracting the second index value from the first index value. In the previous example, the third index value (unweighted) for households purchasing “environmentally friendly products”, aged 18-25 years, would be equal to 45.72 (e.g., the first index value (114.56) minus the second index value (68.84)). In particular, the combination 202 determines the third index value, which generally indicates that the extent to which the 18-25 year-old cohort claims environmentally friendly products are important to them exceeds their relative purchase level. In scenarios where the third index value is negative, the combination 202 may determine an opposite conclusion, meaning that the cohort reports caring less about this set of products than the amount to which they spend.

In certain embodiments, the combination 202 may generate/determine weighting values for preference values and/or action values (e.g., from the index data). Namely, the combination 202 may generate one or more weighting values for respective preference value and respective action values of the plurality of users based on an indication extracted from a user query. The user query may indicate, for example, that “regenerative agriculture products” are not of particular interest to the entity querying the combination 202 to generate an answer, recommendation, or prediction. The combination 202 may therefore generate a weighting of, e.g., 0.5 to de-emphasize the influence of the preference and/or action values associated with the “regenerative agriculture products” question category. The combination 202 may then determine whether to apply the one or more weighting values to the respective preference values and the respective actions of the plurality of users before or after calculating the first index value and the second index value and determine the third index value based on the first index value and the second index value after applying the one or more weighting values.

As part of this analysis, the combination 202 may normalize values associated with one or more of the index values. For example, the combination 202 may normalize a cohort's household spend level associated with a particular attribute/theme/category (e.g., on a question-by-question basis) to avoid skewing the data by cohorts that buy more or less of a particular product/service due to, e.g., higher overall income levels. The combination 202 may predict normalization values to be applied to data from certain cohorts based on prior normalization values, updated product characteristics, overall entity goals, and/or any other suitable information or combinations thereof that indicate a prioritization or de-prioritization of parameters associated with a product/service and/or the individuals. Thus, in certain embodiments, the combination 202 may normalize one or more parameters for at least one subset of users based on a predicted normalization value associated with the at least one subset of users generated by the combination 202 and determine the third index value based on the first index value and the second index value after normalizing the one or more parameters.

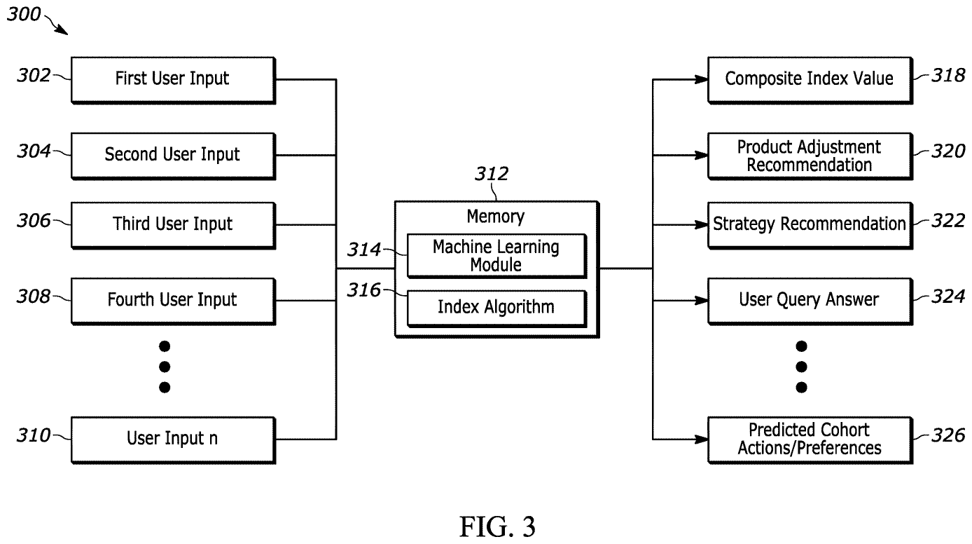

FIG. 3 depicts a second example scenario 300 in which an index algorithm 316 receives a plurality of input data to generate a plurality of output answers and/or recommendations, in accordance with various embodiments described herein. Generally, the second example scenario 300 illustrates a combination 312 of a machine learning module 314 (e.g., module 104b1, 204) and an index algorithm 316 (e.g., algorithm 104b2, 206) receiving one or more user inputs 302-310 to generate one or more outputs 318-326. The user inputs 302 may generally include any of the inputs described herein, such as index data, updates, user queries, prior index data, prior answers provided by the combination 312, prior recommendations provided by the combination 312, prior predictions provided by the combination 312, prior index values (composite or single) output by the combination 312, and/or any other values or combinations thereof. The one or more outputs 318-326 may include, for example, a composite index value 318, a product adjustment recommendation 320, a strategy recommendation 322, a user query answer 324, a predicted cohort action/preference 326, and/or any other suitable outputs or combinations thereof.

As illustrated in FIG. 3, the combination 312 may receive any suitable number of inputs, where n of the user input 310 may be any suitable integer value. For example, in certain scenarios, the combination 312 may only receive the first user input 302, which may include a set of index data (e.g., preferences and/or actions) corresponding to one or more cohorts of interest. In some scenarios, the combination 312 may receive the first user input 302, the second user input 304, the third user input 306, and the fourth user input 308, which may include multiple sets of index data (e.g., preferences and/or actions) corresponding to one or more cohorts of interest, a user query associated with the index data, and/or a prior output of the combination 312. Similarly, the combination 312 may output any one or more of the outputs 318-326 illustrated in FIG. 3 in response to receiving one or more of the inputs 302-310.

The combination 312 may cause or otherwise provide one or more of the outputs 318-326 to a component configured to cause the one or more outputs 318-326 to be displayed for a user. The displayed elements may include various values (e.g., index values) determined/generated by the combination 312, along with interpretations of these values.

For example, the combination 312 may provide a composite index value 318 that is positive and may also provide an interpretation of the positive composite index value 318. Generally speaking, positive composite index values represent a cohort(s) overstating the importance of a preference/motivation in their purchasing decisions, which may have various implications for an entity, and these implications may be incorporated and/or otherwise expressed by the combination 312 as part of one of the other outputs 320-326. In one example, the positive composite index value 318 may indicate that on-pack messaging could be improved and/or updated, and the combination 312 may incorporate this implication in the product adjustment recommendation 320. Additionally, or alternatively, the positive composite index value 318 may indicate that the entity should innovate around these claims by developing entirely new products or incrementally innovate the existing products to bring these claims forward, which the combination 312 may indicate in the strategy recommendation 322.

Further, the positive composite index value 318 may indicate that the entity should consider a revamped pricing and/or promotion strategy that could be spearheaded by crafting a marketing campaign targeting a specific cohort with messaging that elevate these claims. The combination 312 may incorporate all of these insights into the strategy recommendation 322 as well, and may further develop (e.g., based on RAG model supplementation) such a draft marketing campaign strategy, including recommended tag lines, promotion strategies (e.g., discounts, incentives), and/or other recommendations the combination 312 determines are likely to improve (e.g., reduce) the positive composite index value 318. Such recommendations 320, 322 may further include stock keeping unit (SKU) optimization on retail media network recommendations to improve searchability/visibility of the relevant SKUs to the cohort(s) of interest. Accordingly, the indices enable the combination 312 to develop and extrapolate large-scale implications across the entire entity landscape.

As another example, the combination 312 may provide a composite index value 318 that is negative and may also provide an interpretation of the negative composite index value 318. Generally speaking, negative composite index values represent a cohort(s) undervaluing a preference/motivation as affecting their purchasing decisions, which may have various implications for an entity, and these implications may be incorporated and/or otherwise expressed by the combination 312 as part of one of the other outputs 320-326. In one example, the negative composite index value 318 may indicate that the claims presented to the cohort of interest are generally not the motivators of purchase, such that other (positive) claims may be more important to consider for future advancements. The combination 312 may include such recommendations in, for example, a user query answer 324 in response to a user of the entity requesting points of emphasis for a product.

Further, the negative composite index value 318 may indicate that the entity should consider a revamped pricing and/or promotion strategy to create a lower-price point product that contains these claims and sell them to a different cohort. The combination 312 may incorporate all of these insights into a predicted cohort action/preference 326, stating that a different cohort not indicated by the negative composite index value 318 may respond well to this lower-price point product, and may further develop (e.g., based on RAG model supplementation) a draft price point for the product, elements of the product that may be adjusted to accommodate the claims of interest and the reduced profit potential, and/or other recommendations the combination 312 determines are likely to improve the composite index values of such different cohort(s).

Moreover, the combination 312 may include various other values with the composite index value 318. For example, the combination 312 may determine from the inputs 302-310 that the household spend data for 18-25 year olds includes the following values per question (Attribute=household spend): Q1: Compostable Packaging=$250, Q2: Recyclable Packaging=$220, Q3: Free of Harmful Chemicals=$210, Q4: Non-toxic Packaging=$200. Using this household spend data, the combination 312 may determine the potential additional spend per household based on a composite index value of 45.72%. Namely, the combination 312 may determine that the potential additional spending for this cohort associated with the attribute of each question may be:

Potential Additional Spend per Household=Current Spend×0.4572 (4)

Consequently, the combination 312 may determine that the potential additional spending for each represented attribute may be:

(Compostable Packaging) 250×0.4572=114.30250 (5),

(Recyclable Packaging) 220×0.4572=100.58220 (6),

(Free of Harmful Chemicals) 210×0.4572=96.01210 (7),

(Non-toxic Packaging) 200×0.4572=91.44200 (8),

The combination 312 may then determine the total additional spend per household by, for example, summing the potential additional spend across all attributes. Continuing the prior example, the combination 312 may evaluate the total additional spend per household as:

114.30+100.58+96.01+91.44=$402.33(per household) (9)

The combination 312 may also determine the aggregate additional spend for all households within the cohort by multiplying the total additional spend per household by the number of households corresponding to the cohort of interest. For example, the combination 312 may determine the aggregate additional spend for all households in the 18-25 year old cohort by using 8 million households as the representative total households number. Accordingly, the combination 312 may determine the aggregate additional spend for all households in the 18-25-year-old cohort as:

402.33×8,000,000=$3,218,640,000 (10)

With the aggregate additional spend for all households, the combination 312 may further adjust the value based on the motivation/action discrepancy value. In the prior example, this determination is represented by:

3,218,640,000×0.4572=$1,471,385,808 (11),

indicating that, if the 18-25 year old cohort aligns their purchasing behavior with their stated eco-friendly preferences, the total financial opportunity may be approximately $1,471,385,808.

For illustration purposes, a simplified embodiment may compute a simple average spend per household. In such an embodiment, the combination 312 may determine the total financial opportunity from the inputs 302-310 by determining uplift values associated with the average spend per household. For example, the household spend data for 18-25 year olds may include the following values per question (Attribute=household spend): Q1: Eco-friendly packaging=$160, Q2: Regenerative Agriculture=$120, Q3: Environmental Certifications=$80. Using this household spend data, the combination 312 may determine a simple average spend per household of:

(160+120+80)/3=$120(per household) (12),

The combination 312 may then determine the incremental spend per household for all households within the cohort to thereafter determine the total financial opportunity. To determine the incremental spend per household, the combination 312 may determine a composite uplift ratio (e.g., a third index value), which may be a ratio of a first composite index value (e.g., a respective motivation value of 113.1) and a second composite index value (e.g., respective action value of 66.0), which may be represented in this example as:

113.1/66.0=1.7136 (13)

The combination 312 may then utilize the composite uplift ratio from equation (13) to determine a projected spend per household in accordance with the following:

120*1.7136=$205.63 (14),

and which the combination 312 may compare with the simple average spend per household from equation (12) to determine the incremental spend per household, given by:

205.63−120=$85.63 (15)

Using this incremental spend per household, the combination 312 may determine the total financial opportunity by multiplying the incremental spend per household of equation (15) by the total number of households in the particular cohort. Assuming the total number of households in the 18-25 year old cohort is approximately ten million (M), the total financial opportunity may be represented by the following:

85.63*10M=$856.3M (16),

indicating that, if the 18-25 year old cohort aligns their purchasing behavior with their stated preferences, the total financial opportunity may be approximately $856,300,000.

In some embodiments, the combination 312 may include a composite uplift ratio. The composite uplift ratio may be applied either globally to the simple average or individually to each attribute, claim or category level, weighted according to the contribution composite index. As in a more detailed implementation, the system may determine claim level uplift ratios and compute a composite total financial opportunity.

In other embodiments, the system could determine claim attribute or category uplift ratios and calculate the composite total financial opportunity by summing or weighting the uplifted values across all relevant claims or attributes ensuring alignment with actual category level purchase behavior.

Further, in certain embodiments, the combination 312 may also normalize the spending for each cohort analyzed, as income may generally dictate spending across different demographics, and may do so based on a typical/average household consumer spend on one or more specific products (associated with the theme/category of interest) and/or based on the typical/average household consumer spend on all products (irrespective of theme/category).

Regardless, and as mentioned, to facilitate the analysis described herein with a high degree of granularity, the combination 312 may incorporate ML algorithms, e.g., linear regression analysis using gradient boosted decision trees (e.g., via the extreme Gradient Boosting (XGBoost) library). In particular, the combination 312 may utilize the composite index values described herein as the dependent variable in a regression model. By doing so, the combination 312 identifies the survey questions corresponding to a preference composite index (e.g., a first index value), that contribute the most to the motivation/action discrepancy. The combination 312 may thus proceed in constructing and evaluating the linear regression model for one or more cohorts to better understand which survey questions create the largest motivation/action discrepancies, by for example, identifying over-indexing variables (e.g., where cohorts say they prefer a certain question category but do not actually purchase the corresponding products/services) and under-indexing variables (e.g., where cohorts purchase the corresponding products/services more than their stated preference).

The combination 312 may designate the composite index value (e.g., a third index value) representing the motivation/action discrepancy (e.g., between the first index value and the second index value) as the dependent variable, as this composite index value is generally represented as the difference between the preference (first) index value and the action (second) index value. The combination 312 further designates individual questions corresponding to stated preferences as independent variables. The combination 312 may also determine and/or apply weightings for one or more of these independent variables. As an example, the regression model generated and applied/evaluated by the combination 312 may be represented as:

Composite Index Value=β0+β1×Q1+β2×Q2+ . . . +β3×(Q3×1.1)+ . . . +ϵ (17),

where, Qi are the responses corresponding to respective questions, β0 is the intercept value, and β1,β2, etc. are the coefficients representing the weight of each question. In this example equation (17), question three (e.g., Q3) is weighted using a weighting factor (e.g., 1.1). The combination 312 may output this composite index value along with an analysis of any one or more of the individual coefficients associated with respective question responses. For example, positive coefficients (e.g., βi>0) may indicate that the cohort overstates the importance of that attribute/claim, while negative coefficients (e.g., βi<0) may indicate that the cohort understates the importance of that attribute/claim.

In certain embodiments, each of the coefficients (e.g., βi) of equation (17), and of linear regressions determined by the combination 312 more generally, may be index “sub-values” that represent motivation/action discrepancies for individual questions. In these embodiments, the combination 312 may execute a linear regression algorithm that is configured to determine a first index sub-value for each preference value and a second index sub-value for each corresponding action value. Each first index sub-value and each second index sub-value may represent a sub-value of the third index value. The combination 312 may further combine these first index sub-values and the corresponding second index sub-values to generate the coefficients represented, for example, in equation (17). The combination 312 may also determine a weighting value for each first index sub-value and each second index sub-value, determine an intercept value (e.g., β0) corresponding to a predicted third index value associated with each combination of first index sub-values and second index sub-values being zero, and determine the third index value (e.g., composite index value) based on a weighted, linear combination of the first index sub-values and the second index sub-values (themselves combined into, for example, the coefficients of equation (17)).

In some embodiments, the combination 312 may further analyze a magnitude and a direction of each combination of first index sub-value and second index sub-value (e.g., the coefficients of, for example, equation (17)) to determine one or more threshold index values, as described herein. The combination 312 may further generate a predicted outcome based on the third index value and each of the one or more threshold index values and cause the predicted outcome to be displayed on the user interface.

In any event, by utilizing a regression similar to the example represented by equation (17), the combination 312 is able to evaluate questions (variables) concurrently, which allows the combination 312 to account for how different questions interact and/or overlap relative to their impact on the composite index value. Based on the outcome of the regression model, the combination 312 can determine a magnitude of impact and a directional influence on the dependent variable (i.e., the composite index value) for each panel/survey question based on their associated coefficients. Thus, the combination 312 can determine how much each individual survey response contributes to the overall composite index value based on the magnitude/direction of the associated coefficient and can rank the survey questions based on their respective coefficients to identify those resulting in the largest gaps (e.g., positive or negative) of the composite index value.

Further, the combination 312 can calculate and leverage p-values to perform significance testing on the individual questions. The combination 312 may analyze the p-values of one or more questions to determine which survey questions have a meaningful impact on the composite index value, as some questions may not significantly contribute to the composite index value. This p-value calculation and analysis thereby enables the combination 312 to identify and expand on more relevant factors more easily than is typically possible. Such p-value significance testing performed by the combination 312 is further influential when the combination 312 weights variables (e.g., independent variable) via composite indices, as the results enable the combination 312 to adjust the regression for such weights and determine whether the weighted questions have an outsized impact on the composite index value.

The combination 312 may also apply other techniques to the regression analysis described herein. For example, the combination 312 may impose controls to account for multicollinearity. Certain questions may overlap and/or be otherwise closely related, such that when the combination 312 controls for multicollinearity within the regression, the combination 312 can more accurately account for the extent to which each of the questions contributes to the composite index value. The regression performed by the combination 312 also improves the reliability of the resulting composite index value because the regression handles interaction effects, which allows the combination 312 to uncover complex relationships between the independent variables.

Moreover, the regression analysis may enable the combination 312 to perform various predictions, such as leveraging the regression to predict the size of composite index value for future cohorts based on future answers to the same set of questions (e.g., as may be indicated in the predicted cohort actions/preferences 326). In certain embodiments, the combination 312 may execute a ML model to predict a future third index value for at least one of the groups of users based on a first set of index data and a second set of index data, as may be represented in a predicted cohort action/preference (e.g., 326). The combination 312 may further predict, by the ML model, a product recommendation (e.g., product adjustment recommendation 320, strategy recommendation 322) based on the future third index value and cause the product recommendation to be displayed on a user interface.

Additionally, or alternatively, the combination 312 may layer the regression analysis described herein with cloud-based solution that incorporates ML models to deliver a continuous feedback loop for entities relative to the status of emerging areas of opportunity, similar to the continuous feedback loop illustrated in FIG. 2. For example, the combination 312 may evaluate index data with respect to specific cohorts, themes, and/or categories where the composite index value is greater than 100 or any suitable value and may evaluate the updated index data in view of prior data and/or outputs of the ML model to demonstrate progress relative to reducing the composite index value(s).

In particular, to quantify these trends over time, the combination 312 may run a time-series regression to model how the composite index value changes over time (e.g., from the first time instance 208 to the second time instance 212). For example, the combination 312 may determine the time-series regression on a quarter-by-quarter basis in accordance with the following equation:

Composite Index Value(Q1)=β0+β1×Time(Quarter)+ϵ (18),

where β0 is the intercept representing an initial value of the composite index value at the start of the period, β1 is the slope representing the change in the composite index value over time, Time (Quarter) represents the quarter (e.g., Q1 2022, Q2 2022, etc.), and ϵ represents an error value.

In one example, the combination 312 may utilize equation (18) to determine that β0=0.18, indicating the initial composite index value for compostable packaging in Q1 2022. The combination 312 may further determine that β1=−0.03, indicating that the composite index value is decreasing by 0.03 units per quarter. The combination 312 may determine an interpretation based on these values that the negative coefficient β1 indicates that the gap between what a cohort says and what they buy is narrowing over time. Specifically, the composite index value for compostable packaging decreases by 0.03 units per quarter, showing that the cohort's behavior is becoming more aligned with their stated preferences. The combination 312 can thereafter track the progress of subsequent changes/adjustments to products related to compostable packaging and determine whether any eco-friendly product offerings are effectively closing the gap between cohort demand and purchasing behavior.

The combination 312 can thus layer high action index values (e.g., where cohorts are already spending), identify areas of opportunity (as previously discussed) from the composite index value, and layer in regression analysis to statistically determine which variables (e.g., survey responses, etc.) show the most promise for optimizing the motivation/action discrepancy. The combination 312 may further leverage these insights to generate recommendations for each individual department/industry of an entity where areas of opportunity present themselves (e.g., new product innovation, marketing campaign support/recommendations, merchandising and assortment, pricing & promotion, etc.).

As part of these analysis and output, the combination 312 may also generate and schedule distribution of survey questions that are consistently provided to cohorts for consistent tracking of index values over time. The combination 312 can thus link the survey questions and responses to purchase data (e.g., received/accessed from a data supplier), giving a consistent, steady stream of data relative to any observed changes (e.g., compared to a baseline).

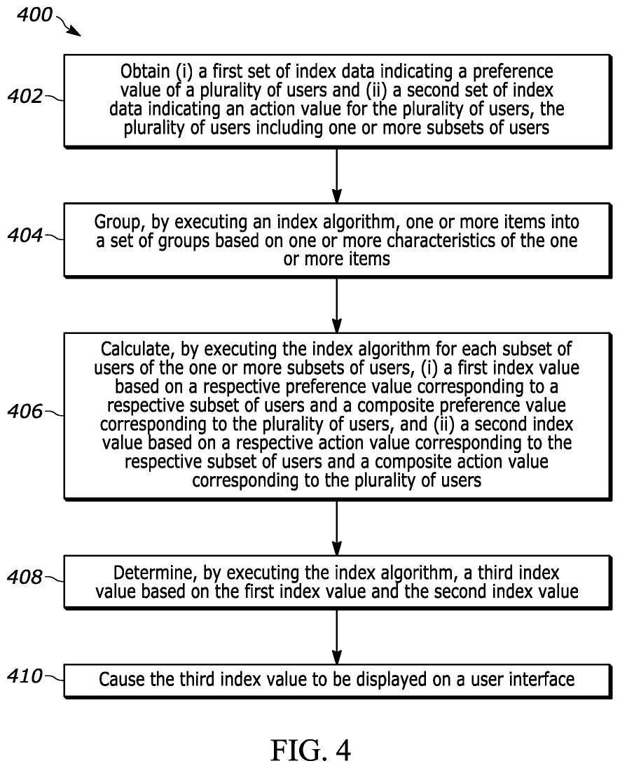

FIG. 4 illustrates an example method 400 for comparative index analysis. The actions described herein in reference to the example method 400 may be performed by any of the components of the example computing system 100 (e.g., central server 104, index algorithm 104b2). At block 402, the example method 400 includes obtaining (i) a first set of index data indicating a preference value of a plurality of users and (ii) a second set of index data indicating an action value for the plurality of users, the plurality of users including one or more subsets of users. The example method 400 further includes grouping, by executing an index algorithm, one or more items into a set of groups based on one or more characteristics of the one or more items (block 404).

At block 406, the example method 400 further includes calculating, by executing the index algorithm for each subset of users of the one or more subsets of users, (i) a first index value based on a respective preference value corresponding to a respective subset of users and a composite preference value corresponding to the plurality of users, and (ii) a second index value based on a respective action value corresponding to the respective subset of users and a composite action value corresponding to the plurality of users. At block 408, the example method 400 further includes determining, by executing the index algorithm, a third index value based on the first index value and the second index value. At block 410, the example method 400 further includes causing the third index value to be displayed on a user interface.

In some embodiments, the example method 400 further includes normalizing, by the index algorithm, one or more parameters for at least one subset of users based on a predicted normalization value associated with the at least one subset of users generated by the index algorithm; and determining, by the index algorithm, the third index value based on the first index value and the second index value after normalizing the one or more parameters.

In some embodiments, the example method 400 further includes generating, by the index algorithm, one or more weighting values for respective preference value and respective action values of the plurality of users based on an indication extracted from a user query; determining, by the index algorithm, whether to apply the one or more weighting values to the respective preference values and the respective actions of the plurality of users before or after calculating the first index value and the second index value; and determining, by the index algorithm, the third index value based on the first index value and the second index value after applying the one or more weighting values.

In some embodiments, the example method 400 further includes receiving a first user query at a first time instance corresponding to the first set of index data and the second set of index data; determining, by the index algorithm, the third index value based on the first user query, the first index value, and the second index value; receiving, a second user query at a second time instance that is different from the first time instance, the second user query corresponding to a third set of index data and a fourth set of index data; determining, by the index algorithm, a sixth index value based on (i) the first user query, (ii) the second user query, (iii) the first index value, (iv) the second index value, (v) a fourth index value, and (vi) a fifth index value, wherein the sixth index value represents an updated third index value; generating, by the index algorithm, a predicted outcome based on the sixth index value and the third index value; and causing the predicted outcome to be displayed on the user interface.

In some embodiments, the example method 400 further includes execute, as part of the index algorithm, a linear regression algorithm configured to: determine a first index sub-value for each preference value and a second index sub-value for each corresponding action value, wherein each first index sub-value and each second index sub-value represents a sub-value of the third index value; determine a weighting value for each first index sub-value and each second index sub-value; determine an intercept value corresponding to a predicted third index value associated with each first index sub-value and each second index sub-value being zero; and determine the third index based on a weighted, linear combination of the first index sub-values and the second index sub-values.

In some embodiments, the example method 400 further includes analyzing, by the index algorithm, a magnitude and a direction of each first index sub-value and each second index sub-value to determine one or more threshold index values; generating, by the index algorithm, a predicted outcome based on the third index value and each of the one or more threshold index values; and causing the predicted outcome to be displayed on the user interface.

In some embodiments, executing the index algorithm includes executing a ML model, and the example method 400 further includes predicting, by the ML model, a future third index value for at least one of the groups of users based on the first set of index data and the second set of index data; predicting, by the ML model, a product recommendation based on the future third index value; and causing the product recommendation to be displayed on the user interface.

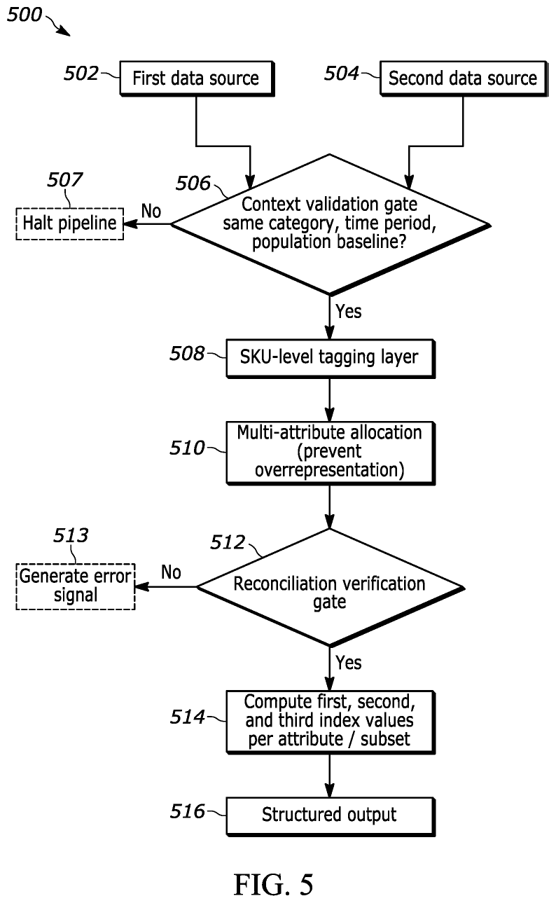

FIG. 5 illustrates an example method 500 for comparative index analysis involving data validation and processing. The example method 500 may be performed by one or more processors executing processor-executable instructions stored in one or more memories, such as the central server 104 executing the index algorithm 104b2. At block 502, the example method 500 receives data from a first data source, and at block 504, the example method 500 receives data from a second data source that is different from the first data source. For example, the first data source may comprise survey responses where respondents rate attribute importance on a scale (e.g., a Top-2 Box (T2B) value) representing, e.g., the percentage of respondents rating an attribute as a 4 or 5 on a 5-point scale. It should be appreciated that the T2B measurement is one example of a preference value measurement, and the present techniques are not limited to T2B. In various embodiments, the preference value may be derived from any suitable measurement methodology, such as Top-Box, T2B, mean score, weighted mean, normalized rating, percentile rank, MaxDiff, conjoint analysis, discrete choice modeling, pairwise comparison, forced rank, stated importance, transformed survey response values, and/or combinations thereof.

Survey questions may be framed with specific category context, such as “When choosing [Category], how important is [attribute]?” to ensure alignment with the decision context. Further, the second data source may comprise, e.g., panel-based purchase data that tracks actual household spending on products at a stock-keeping unit (SKU) level. It should be appreciated that panel data (e.g., survey and purchase panels) is one example of a suitable data source, and the systems described herein may obtain data from any suitable data source including syndicated data, retailer data, loyalty-card data, transaction data, receipt data, e-commerce data, first-party data, third-party data, observational data, behavioral data, and/or automatically collected data or combinations thereof. As one example, the first data source may provide preference values indicating that 85% of respondents in a segment rate “eco-friendly packaging” as a 4 or 5, while the second data source may provide action values indicating that households in the segment spent $160 on products carrying the eco-friendly packaging attribute.

From block 502 and block 504, the example method 500 may further include executing a context validation gate (block 506), where the systems described herein determine whether the data sources share the same category, time period, and/or population baseline. The population baseline may be defined as all households purchasing category C in time period T, and all indices may be calculated relative to this same population baseline. If the validation at block 506 fails (No branch), the example method 500 may proceeds to block 507, where the data is rejected or flagged as structurally invalid and the processing pipeline is halted. For example, if the survey questions reference a broader or different context than the purchase data (e.g., the survey asks about “snacks” generally while the purchase data covers only “salty snacks”), the system rejects the calculation as structurally invalid at block 507.

However, if the validation at block 506 succeeds (Yes branch), the example method 500 continues to block 508, which involves a SKU-level tagging layer where attributes are mapped to individual products. In particular, at block 508, the index algorithm groups each of a plurality of attributes with one or more items based on one or more characteristics of the items. These characteristics may be or comprise defined tagging rules, such as one or more of: (i) an on-pack claim, (ii) an ingredient composition, and/or (iii) an item description. Each item/product is generally identified at the SKU level, and the system may exclude any attribute for which fewer than a threshold number of items in the category are identifiable as carrying the attribute based on the defined tagging rules. For example, a snack product may be tagged with the “baked” attribute based on an on-pack claim, the “made with olive oil” attribute based on ingredient composition, and the “reduced fat” attribute based on the product description.

Following block 508, the example method 500 may further include performing multi-attribute allocation to prevent overrepresentation when products carry multiple attributes (block 510). For each item associated with a plurality of attributes, the system may allocate an action value associated with the item across the plurality of attributes such that a total of allocated action values across all attributes does not exceed a total category action value. Allocating the action value may comprise dividing the action value for the item equally across a number k of attributes associated with the item. For example, if a SKU carries three attributes (e.g., baked, olive oil, and reduced fat) and has $30 in associated spend, the system allocates $10 to each attribute.

In certain embodiments, the systems described herein may allocate the action value across multiple attributes using alternative allocation methods beyond equal division. For example, the system may allocate action values using rule-based allocation (e.g., predefined rules determine allocation percentages based on attribute characteristics), proportional allocation (e.g., allocation is proportional to attribute prevalence or importance), confidence-weighted allocation (e.g., allocation is weighted by the confidence score of each attribute tag), hierarchy-weighted allocation (e.g., primary attributes receive greater allocation than secondary attributes), model-derived allocation (e.g., a machine learning model determines optimal allocation based on historical data), and/or combinations thereof. The systems described herein may determine/select specific allocation methods based on category characteristics, data availability, and/or analytical objectives, among other parameters, and these systems may apply different allocation methods to different categories or supercategories.

From block 510, the example method 500 may further include executing a reconciliation verification gate at block 512, where the system verifies that total allocated action values across all attributes equal a total category-level action value. If the verification at block 512 fails (No branch), the example method 500 generally proceeds to block 513, where an error signal is generated and downstream computation of the first index value, the second index value, and the third index value is prevented until the total allocated action values are reconciled to the total category-level action value. For example, if the sum of allocated spend across all attributes equals $950,000 but the total category spend equals $1,000,000, the system generates an error signal at block 513 and halts further processing. By generating the error signal and halting the pipeline at block 513, the system prevents the one or more processors from unnecessarily expending computational resources on downstream processing tasks (e.g., index calculations, composite constructions, opportunity state classifications, etc.). As mentioned, this is particularly significant at scale, as the system may process data across tens or hundreds of thousands of items, each carrying one or more attributes. Permitting the pipeline to proceed with unreconciled allocation values would cause the structural error to propagate through every downstream computation for every attribute and every subset of users, thus compounding the consumption of processing resources on outputs that lack analytical validity.

In certain embodiments, if the reconciliation verification at block 512 fails, the system may respond in various ways beyond generating an error signal and halting the pipeline. For example, the system may flag the output with a reconciliation warning while permitting downstream computation to proceed, and/or suppress monetization estimates while permitting index calculations to proceed. Additionally, or alternatively, the systems described herein may route the data to a separate review processing path for manual reconciliation, generate a partial output excluding attributes with reconciliation failures, and/or automatically attempt re-allocation using an alternative allocation method. The specific failure response may be configured based on the magnitude of the reconciliation discrepancy, the analytical context, and/or user-defined tolerance thresholds.

If the verification at block 512 succeeds (Yes branch), the example method 500 further includes determining a first index value, a second index value, and a third index value per attribute or subset of users (block 514). Namely, the index algorithm determines, for each attribute and for each subset of users of one or more subsets of users: (i) a first index value based on a respective preference value corresponding to the respective subset of users and a composite preference value corresponding to the plurality of users, and (ii) a second index value based on a respective allocated action value corresponding to the respective subset of users and a composite allocated action value corresponding to the plurality of users. The first index value (Say Index) may be calculated using the equation:

$${SayIndex}_{S} ( a ) = \frac{T 2 {B}_{S} ( a )}{T 2 {B}_{pop} ( a )} \times 100 , \qquad ( 19 )$$

where T2B_{S}(a) is the segment percentage rating attribute a as a 4 or 5, and T2Bₚₒₚ(a) is the total population percentage rating the attribute as a 4 or 5. The second index value (Do Index) may be calculated in accordance with the equation:

$${DoIndex}_{s} ( a ) = \frac{{Spend}_{s} ( a )}{{Spend}_{pop} ( a )} \times 100 , \qquad ( 20 )$$

where Spendₛ(a) is segment spend on attribute a and Spendₚₒₚ(a) is total population spend on the attribute. The index algorithm further determines, for each attribute, a third index value based on the first index value and the second index value. The third index value (Say-Do Gap) may be calculated as:

Gapₛ(a)=SayIndexₛ(a)−DoIndexₛ(a) (21)

Generally, a positive gap indicates unrealized demand where stated preferences exceed observed behavior, a negative gap indicates validated behavioral strength where observed behavior exceeds stated preferences, and a near-zero gap indicates alignment between preferences and actions. For example, if a segment has a Say Index of 120 and a Do Index of 80 for the “organic” attribute, the Say-Do Gap equals 40, indicating unrealized demand.

The example method 500 further includes providing a structured output to a user interface (block 516). In particular, the system may cause the third index value for each attribute to be displayed on the user interface, and the structured output may comprise: attribute-level first, second, and third index values for each attribute and each subset of users; weighting tables; base sizes; stability indicators; and/or spend reconciliation data confirming that total allocated action values equal total category action values. Minimum recommended survey sample sizes may include 800-1,000 total population respondents, 150-200 minimum per segment, and 50-75 respondents per attribute Top-2 Box base. If margin of error exceeds ±8-10 index points, the result may be treated as directional only rather than definitive. The structured output may further include documentation of SKU-to-attribute tagging logic, overlap correction method, proof that total attributed dollars equal category dollars, and percentage of SKUs carrying multiple attributes. For example, the output may display that the 18-25 year old segment has a Say Index of 114, a Do Index of 69, and a Say-Do Gap of 45 for eco-friendly packaging attributes, along with a base size of 200 respondents and a stability flag indicating the result meets minimum thresholds.

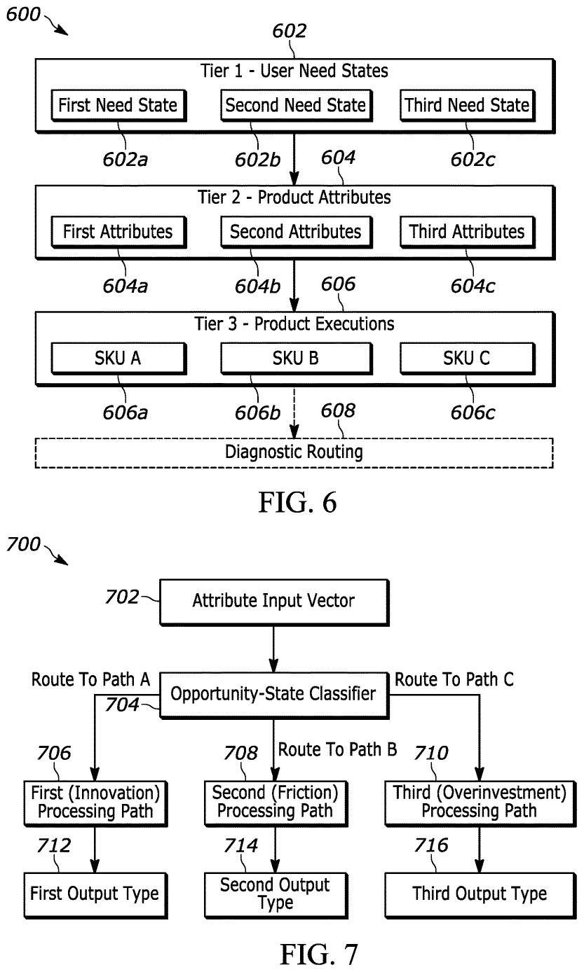

FIG. 6 depicts a hierarchical analysis framework 600 that organizes comparative index analysis across multiple, distinct tiers. The hierarchical analysis framework 600 enables determination of root causes for demand gaps at the attribute level by defining relationships between user (consumer) motivations, product features, and observable market behavior.

At the top of the hierarchical analysis framework 600, a user need states tier 602 contains a first need state 602a, a second need state 602b, and a third need state 602c. User need states represent underlying motivations or outcomes that drive purchasing decisions. For example, the first need state 602a may represent gut health, the second need state 602b may represent energy, and the third need state 602c may represent satiety. Survey data may be used to measure user need states, and the index algorithm may normalize one or more parameters for at least one subset of users based on a predicted normalization value associated with the at least one subset of users generated by the index algorithm. The index algorithm may then determine the third index value based on the first index value and the second index value after normalizing the one or more parameters.

Associated with the user need states tier 602 is a product attributes tier 604 containing a first attribute 604a, a second attribute 604b, and a third attribute 604c. Product attributes generally represent features or claims that signal or deliver the consumer need states. For example, the first attribute 604a may represent “baked,” the second attribute 604b may represent “made with olive oil,” and the third attribute 604c may represent “reduced fat.” The user need states tier 602 are associated with the product attributes tier 604 at least in that the product attributes serve as measurable proxies for underlying user motivations. Product attributes are measurable in both survey responses and product data, and the third index value is generally calculated at the attribute level. The index algorithm may generate one or more weighting values for respective preference values and respective action values of the plurality of users based on an indication extracted from a user query. Moreover, the index algorithm may determine whether to apply the one or more weighting values to the respective preference values and the respective actions of the plurality of users before or after calculating the first index value and the second index value, and determine the third index value based on the first index value and the second index value after applying the one or more weighting values.

Associated with the product attributes tier 604 is a product executions tier 606, which contains a first SKU (SKU A) 606a, a second SKU (SKU B) 606b, and a third SKU (SKU C) 606c. These product executions generally represent observable products and formats identified at the SKU level. For example, SKU A 606a may represent a specific baked chip product, SKU B 606b may represent an olive oil-based snack product, and SKU C 606c may represent a reduced fat cracker product. These executions are generally linked with the product attributes tier 604 because product-level behavior is generally mapped to attributes and all behavioral measurement remains anchored at the attribute level. Panel-based purchase behavior captures product executions, and the system may map product-level behavior to attributes through defined tagging rules.

A supercategory, as used herein, generally refers to a higher-level grouping of related product categories that share common consumption contexts, distribution channels, and/or consumer decision frameworks. The systems described herein may organize categories into supercategories to enable structured comparison of attribute-level indices across related but distinct product categories within the same grouping. Supercategories such as Salty Snacks, Cookies and Crackers, Health and Performance, Nutritional and Cereal Bars, and Oils/Butter/Margarine/Spreads/Substitutes may require separate model recalculation because attribute meaning changes by context. For example, “gluten free” in chips carries a different meaning than “gluten free” in cereal bars, and “portion control” in snacks differs from “portion control” in spreads. The primary analytical unit for a baked plus olive oil use case may be Salty Snacks with subcategories within Salty Snacks (such as chips and popcorn as separate analytical units), while keeping Oils/Butter/Margarine analytically separate. Broader supercategories may be run when evaluating cross-portfolio strategy or testing platform portability.

A diagnostic routing module 608 included as part of the framework 600 determines whether an attribute-level gap indicated by the third index value is driven by an unmet consumer need, an attribute-level misalignment, and/or a product execution performance issue. For example, when the diagnostic routing module 608 receives a positive third index value for the “baked” attribute, the diagnostic routing module 608 may evaluate whether the gap results from consumers having unmet needs for healthier snack options (unmet consumer need). Alternatively, the module 608 may determine the “baked” attribute fails to adequately signal the desired health benefits (attribute-level misalignment), and/or that specific baked products underperform relative to consumer expectations (product execution performance issue). Overall, this hierarchical relationship represented by the framework 600 enables the system to route attributes through distinct analytical pathways and generate targeted recommendations based on the identified root cause of demand gaps.

FIG. 7 illustrates an example method 700 for opportunity-state classification and routing within the comparative index analysis framework. The example method 700 begins with an attribute input vector 702, which contains attribute-level information derived from preference and action indices. For example, the attribute input vector 702 may include, for a given attribute such as “baked” or “organic,” the first index value, the second index value, the third index value, and a saturation value representing behavior-weighted attribute exposure across a supercategory. An opportunity-state classifier 704 receives the attribute input vector 702 and analyzes the input data to determine an appropriate processing path based on characteristics of the attribute data. The opportunity-state classifier 704 evaluates parameters including the first index value, the second index value, and the saturation value to route the data to one of three distinct processing paths. In some cases, the opportunity-state classifier 704 applies a rule-based classification to classify each attribute into an opportunity state based on a combination of the first index value, the second index value, the third index value, and/or the saturation value. An opportunity state, as used herein, generally represents a classification of the market condition associated with a particular attribute based on the relationship between stated consumer preferences, observed purchasing behavior, and market supply dynamics. Each opportunity state indicates a distinct underlying condition, such as unmet demand in an undersupplied market, purchase barriers in a well-supplied market, or excess investment in an attribute that consumers do not prioritize, and correspondingly determines how the system processes and generates outputs for that attribute.

Based on the opportunity state, the opportunity-state classifier 704 selects a processing path from a plurality of different processing paths, wherein each processing path generates a different type of output for the attribute. A first processing path 706 (Path A) processes attributes characterized by a high first index value, a low second index value, and low saturation. Generally, this first processing path 706 may be an innovation processing path. Namely, when the first index value exceeds a first threshold, the second index value is below a second threshold, and the saturation value is below a third threshold, the opportunity-state classifier 704 classifies an innovation opportunity and routes the attribute to the first processing path 706. A high positive third index value (Say-Do Gap) processed through the first processing path 706 exposes unfulfilled consumer intent where stated interest exceeds purchase behavior, highlighting whitespace for innovation. For example, if consumers express strong preference for “prebiotic” snacks but purchase behavior remains low and few products carry the attribute, the first processing path 706 generates a first output type 712 comprising an innovation-opportunity recommendation, such as developing new products carrying the attribute.

A second processing path 708 (Path B) processes attributes characterized by a high first index value, a low second index value, and high saturation. Generally, this second processing path 708 may be an friction processing path. Specifically, when the first index value exceeds the first threshold, the second index value is below the second threshold, and the saturation value exceeds the third threshold, the opportunity-state classifier 704 classifies a friction opportunity and routes the attribute to the second processing path 708. For example, if consumers express strong preference for “baked” snacks but purchase behavior remains low despite many products carrying the attribute, the second processing path 708 generates a second output type 714 comprising a friction-reduction recommendation, such as adjusting price, placement, and/or messaging to remove barriers to purchase.

A third processing path 710 (Path C) processes attributes characterized by a low first index value, a high second index value, and high saturation. Generally, this third processing path 710 may be an overinvestment processing path. Namely, when the first index value is below the first threshold, the second index value exceeds the second threshold, and the saturation value exceeds the third threshold, the opportunity-state classifier 704 classifies an overinvestment signal and routes the attribute to the third processing path 710. A negative third index value processed through the third processing path 710 reveals where users buy more than they claim to care about, showing attributes that have become ubiquitous or table stakes and surfacing premiumization opportunities. For example, if consumers do not express strong preference for “reduced sodium” but purchase behavior is high and the market is saturated with reduced sodium products, the third processing path 710 generates a third output type 716 comprising an overinvestment rebalancing recommendation, such as reallocating resources to higher-opportunity attributes. A low or near-zero third index value may confirm that brand, message, and market behavior are in sync, validating the current strategy and signaling limited whitespace for innovation.

It should be appreciated that the specific recommendation types generated by each processing path (e.g., innovation-opportunity recommendations, friction-reduction recommendations, overinvestment rebalancing recommendations) are illustrative examples and are not intended to limit the scope of the present techniques. In various embodiments, each processing path may generate any suitable type of output, such as scores, rankings, flags, alerts, visualizations, signals, classifications, routing instructions, and/or recommendations or various combinations thereof. The systems described herein may also generate these various outputs based on any suitable combination of the first index value, the second index value, the third index value, and/or the saturation value.

Further, it should be appreciated that the specific opportunity state classifications described herein (e.g., innovation opportunity, friction opportunity, overinvestment signal) are illustrative examples and are not intended to limit the scope of the present techniques. In certain embodiments, the system may classify attributes into additional or alternative opportunity states, such as a validated-but-crowded state (e.g., corresponding to high first index value, high second index value, and high saturation value, indicating strong preference-action alignment in a saturated market); a near-zero alignment state (e.g., corresponding to a third index value near zero, indicating that stated preferences and observed behavior are substantially aligned); a defensive positioning state (e.g., indicating that competitive saturation may erode differentiation); a strategic alignment state or validated alignment state (e.g., corresponding to high first index value and high second index value, indicating that both stated preferences and observed behavior exceed population baselines); and/or other classification states based on the specific analytical context. When the opportunity state indicates, e.g., strategic alignment or validated alignment, the system may generate outputs recommending maintaining, scaling, defending, monitoring, and/or optimizing the attribute or platform rather than recommending innovation or friction-reduction actions. More generally, the saturation value may be used to contextualize, rank, flag, score, classify, visualize, and/or route Say-Do outputs in any manner that informs downstream processing or recommendation generation. The systems described herein may utilize and/or otherwise configure the specific classification rules and labels based on category characteristics, brand strategy, and/or other user-defined criteria.

In some embodiments, the first threshold may be a value above 100 (e.g., 110, 115, 120), indicating that the segment rates the attribute as more important than the population average. For example, a first threshold of 110 indicates that the segment's stated preference for the attribute exceeds the population baseline by at least 10%. The second threshold may also be a value at or near 100 (e.g., 95, 100, 105), indicating that the segment's purchasing behavior for the attribute is at or below the population average. A second index value below 100 generally indicates that the segment spends less on products carrying the attribute than the average population, despite the segment's stated preference exceeding the population average. The third threshold for the saturation value may be set relative to the distribution of saturation values within the supercategory, such as a z-score below zero or a value below the median saturation across all attributes in the supercategory. A low saturation value generally indicates that relatively few products carrying the attribute are present in the market (as measured by behavior-weighted exposure), suggesting that the gap between stated preference and observed behavior may be attributable to insufficient product availability rather than consumer disinterest. The specific threshold values may vary by category, supercategory, and/or analytical context, and may be adjusted based on the distribution characteristics of the underlying data.

The example method 700 may further support iterative time-based processing. The system may receive a first user query at a first time instance corresponding to a first set of index data and a second set of index data, and the index algorithm may determine the third index value based on the first user query, the first index value, and the second index value. The system may then receive a second user query at a second time instance that is different from the first time instance, the second user query corresponding to a third set of index data and a fourth set of index data. The index algorithm may determine a sixth index value based on (i) the first user query, (ii) the second user query, (iii) the first index value, (iv) the second index value, (v) a fourth index value, and (vi) a fifth index value, wherein the sixth index value represents an updated third index value. For example, if the third index value for “organic” at the first time instance indicates an innovation opportunity, and updated index data at the second time instance shows increased purchase behavior, the sixth index value may reflect a reduced gap. The index algorithm may generate a predicted outcome based on the sixth index value and the third index value, and the system may cause the predicted outcome to be displayed on the user interface. For example, the predicted outcome may indicate that prior recommendations successfully reduced the preference-action gap for the attribute, and may further recommend continued investment or reallocation to other opportunity areas.

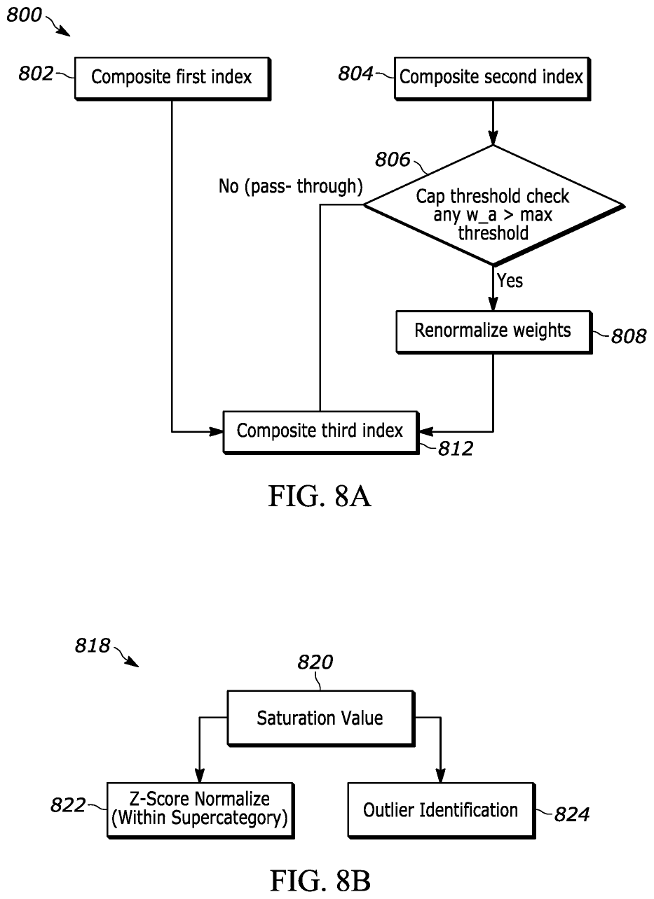

FIG. 8A illustrates an example method 800 for constructing composite indices that aggregate attribute-level measurements into platform-level metrics. The example method 800 begins with two parallel input paths that generally comprise determining distinct composite values using different weighting structures. At block 802, the present systems determine a composite first index as an equal-weight average across attributes in a platform using the formula

$${CompositeSay}_{s} = \frac{1}{\vert A \vert} \times {\sum }_{a ∈ A} {SayIndex}_{s} ( a ) , \qquad ( 22 )$$

where |A| represents the number of attributes in set A and SayIndexₛ(a) represents the first index value for attribute a in segment s. For example, if a platform comprises three attributes (e.g., baked, olive oil, reduced fat) with first index values of 115, 108, and 122 respectively for a segment, the Composite First Index equals (115+108+122)/3=115. One or more weighting values applied to the first index values may be determined based on conceptual importance, and alternative weights for the Composite First Index may be derived from independent importance measures such as a MaxDiff or a conjoint analysis rather than equal weighting. Weighting may be applied to either the say or do side to reflect specific strategic priorities.

At block 804, the present systems determine a composite second index as a weighted sum, where each weight wₐ equals

$$\frac{TotalPopSpend ( a )}{{\sum }_{j} TotalPopSpend ( j )} , \qquad ( 23 )$$

for all attributes j in set A, and

CompositeDoₛ=Σ_{aεA}wₐ×DoIndexₛ(a) (24)

One or more weighting values applied to the second index values may be determined based on economic scale, and the weighting structures for the first index values and the second index values may remain distinct and are not combined without explicit justification. For example, if total population spend across three attributes equals $500M (baked), $300M (olive oil), and $200M (reduced fat), the weights equal 0.50, 0.30, and 0.20 respectively.

From block 804, the example method 800 may proceed to block 806, where the systems described herein perform a cap threshold check to determine whether any weight wₐ exceeds a maximum threshold. If the threshold is exceeded (Yes branch), the example method 800 further include capping the weight(s) at the maximum value and renormalizing the weight(s) so that the sum of all weights equals one, thereby preventing the composite second index value from becoming computationally dependent on a single attribute. For example, if the maximum threshold is 0.40 and the baked attribute has a weight of 0.50, the systems described herein may cap the weight at 0.40 and renormalize the remaining weights proportionally.

However, if no weight exceeds the threshold (No branch, indicated as pass-through), the example method 800 bypasses block 808 and proceeds directly to block 812, where the systems described herein output a composite third index, which may also represent the composite gap (e.g., Say-Do gap). The composite gap is generally calculated as:

CompositeGapₛ=CompositeSayₛ−CompositeDoₛ (25),

reflecting opportunity adjusted for economic scale. The systems described herein may further determine a composite uplift calculated as:

$${CompositeUplift}_{s} = \frac{{CompositeSay}_{s}}{{CompositeDo}_{s}} \qquad ( 26 )$$

The composite uplift generally represents a ratio-based expression of the relationship between aggregated stated importance and aggregated observed purchasing behavior at the platform level. A composite uplift value greater than one indicates that stated preferences across the platform exceed observed purchasing behavior, suggesting unrealized demand across the grouped attributes, while a composite uplift value less than one indicates that observed purchasing behavior exceeds stated preferences, suggesting validated behavioral strength. The systems described herein may utilize the composite uplift as a secondary signal for prioritization purposes, helping to rank platforms by the magnitude of opportunity they represent. However, the composite uplift does not directly translate to revenue and is generally used in conjunction with the composite gap rather than as a replacement for it. Moreover, the systems described herein may determine an uplift metric for individual attributes in accordance with the following equation:

$${Uplift}_{s} ( a ) = \frac{{SayIndex}_{s} ( a )}{{DoIndex}_{s} ( a )} , \qquad ( 27 )$$

to rank priority, though the uplift metric does not directly translate to revenue. The framework of the present systems thus pinpoints which attributes and claims exert the greatest influence on shifts in alignment or behavior.

As part of the index algorithm, the systems described herein may execute a linear regression algorithm to determine a first index sub-value for each preference value and a second index sub-value for each corresponding action value, wherein each first index sub-value and each second index sub-value represents a sub-value of the third index value. The linear regression algorithm may determine a weighting value for each first index sub-value and each second index sub-value, and may determine an intercept value corresponding to a predicted third index value associated with each first index sub-value and each second index sub-value being zero. Further, the systems described herein executing the linear regression algorithm may determine the third index based on a weighted, linear combination of the first index sub-values and the second index sub-values. This may include, e.g., analyzing a magnitude and a direction of each first index sub-value and each second index sub-value to determine one or more threshold index values. For example, a positive coefficient indicates that a cohort overstates the importance of an attribute, while a negative coefficient indicates that the cohort understates the importance of that attribute. The index algorithm may generate a predicted outcome based on the third index value and each of the one or more threshold index values, and the system may cause the predicted outcome to be displayed on the user interface.

FIG. 8B illustrates an example saturation method 818 for calculating behavior-weighted attribute exposure across a supercategory. The example saturation method 818 begins at block 820, which defines a saturation value as the behavior-weighted attribute exposure across a supercategory. This saturation value is generally determined in accordance with the following equation:

Saturation(a)=Σᵢ[actionᵥₐₗᵤₑ₍ᵢ₎×market_{footprint(i)}] (28),

for all items i carrying attribute a. The action_value(i) may represent household spend associated with item i, and the market_footprint(i) may represent distribution breadth, shelf presence, and/or weighted all-commodity volume (ACV) for item i. For example, if three SKUs carry the “baked” attribute with action values of $100M, $80M, and $60M and market footprints of 0.9, 0.7, and 0.5 respectively, the saturation value equals (100M×0.9)+ (80M×0.7)+ (60M×0.5)=$176M.

The example saturation method 818 further includes performing a z-score normalization within the supercategory, which standardizes the saturation values relative to other attributes in the same supercategory (block 822). Generally, such z-score normalization enables comparison of saturation levels across attributes with different absolute scales by expressing each saturation value in terms of standard deviations from the supercategory mean. For example, an attribute with a z-score above 2.0 may indicate market saturation, while an attribute with a z-score below −1.0 may indicate limited market presence and potential innovation opportunity. It should be appreciated that z-score normalization is one example of a normalization methodology, and the present techniques are not limited to z-score normalization. In various embodiments, the saturation value may be normalized using any suitable methodology, such as percentile ranking, min-max normalization, robust z-score, interquartile range (IQR) normalization, winsorization, quantile binning, and/or other distribution-based normalization methods. Similarly, the Herfindahl-based index described herein for outlier identification is one example of a concentration or outlier detection methodology, and the present techniques may alternatively or additionally utilize Gini coefficients, entropy measures, concentration ratios, and/or other suitable concentration or outlier detection methods.

The method 818 further includes performing outlier identification, which detects attributes with saturation values that deviate from expected patterns (block 824). The systems described herein may perform this outlier identification using any suitable methodology, such as a Herfindahl-based index applied to the saturation values within the supercategory to identify attributes with concentrated or anomalous market presence. For example, if a supercategory contains five attributes with saturation values of $176M, $150M, $140M, $130M, and $50M, the Herfindahl-based index may square each attribute's share of total saturation to identify whether any single attribute disproportionately concentrates market presence. In this example, the attribute with $50M in saturation may be identified as an outlier due to its significantly lower behavior-weighted exposure relative to the other attributes in the supercategory, which may indicate an emerging or underrepresented attribute warranting further analysis through the opportunity-state classification of the example method 700. Accordingly, the example saturation method 818 enables the systems described herein to analyze attribute exposure while accounting for both behavioral intensity and market presence, with subsequent normalization and outlier detection to support robust result interpretation.

In certain embodiments, the systems described herein may further analyze whether attribute saturation is concentrated among specific market participants. For example, the system may determine whether saturation for a particular attribute is concentrated among one or more specific brands, manufacturers, retailers, private-label lines, and/or market segments. In doing so, the systems described herein may further determine or otherwise inform the determination of additional outputs, such as competitive saturation indicators (e.g., showing the degree to which competitors dominate an attribute), differentiation erosion signals (e.g., indicating that an attribute is becoming commoditized), incumbent concentration metrics (e.g., showing whether established players control attribute exposure), defensive positioning recommendations (e.g., suggesting strategies to maintain differentiation), reduced distinctiveness alerts (e.g., flagging attributes where competitive parity has eroded brand differentiation), and/or next-attribute opportunity signals (e.g., identifying emerging attributes with low competitive concentration). The systems described herein may thus integrate this saturation analysis with the opportunity-state classification to provide additional context for downstream recommendation generation.

Further, it should be appreciated that the saturation value and the market footprint weighting described herein may be determined at any suitable point in the processing pipeline relative to the determination of the first index value, the second index value, and the third index value. In some embodiments, the saturation value is determined before the first index value and the second index value are determined, such that the saturation value informs the weighting applied during index construction. In other embodiments, the saturation value is determined after the first index value, the second index value, and the third index value have been determined, such that the saturation value contextualizes the interpretation of the gap without affecting the underlying index calculations. This timing flexibility accommodates different analytical objectives and data availability constraints. Moreover, the market footprint weighting addresses the practical reality that products carrying a given attribute may have vastly different levels of market exposure. For example, a product carrying a particular attribute from a large multinational corporation may have distribution across thousands of retail locations worldwide, while a product carrying the same attribute from a small regional producer may have distribution limited to a handful of locations. Without accounting for these differences in market footprint, the saturation value would treat both products as contributing equally to attribute exposure, which may produce a misleading representation of how accessible the attribute is to consumers in the market. The market footprint weighting described herein thus adjusts the saturation calculation to reflect the actual consumer-facing presence of each item, regardless of whether this weighting is applied before or after the third index value is determined.

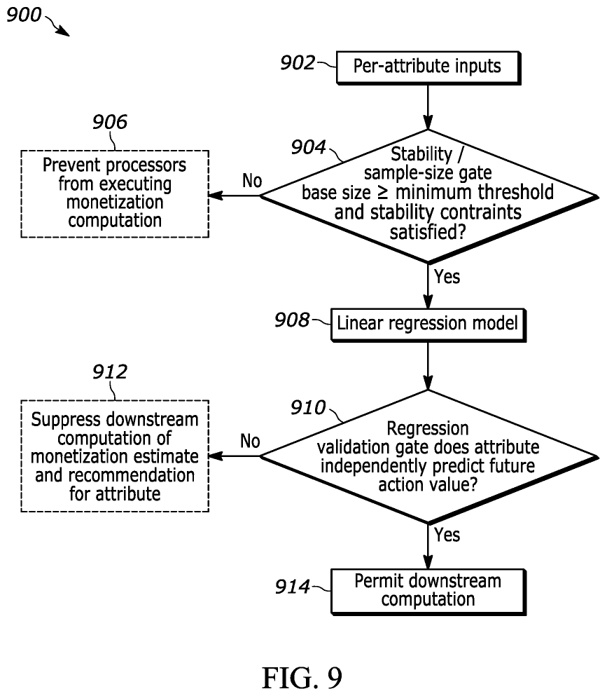

FIG. 9 illustrates an example method 900 for validating attribute-level inputs prior to downstream computation using stability constraints and regression-based incrementality testing. The example method 900 begins at block 902, where the systems described herein receive per-attribute inputs comprising preference values and action values for one or more attributes. For example, the per-attribute inputs may include survey-derived preference data indicating that 78% of respondents in a segment rate “olive oil” as a 4 or 5 on a 5-point scale, along with panel-based action data indicating that households in the segment spent $45 on products carrying the olive oil attribute.

From block 902, the example method 900 proceeds to block 904, which generally represents a stability and sample-size gate. In particular, the systems described herein apply minimum sample size thresholds and stability constraints to the first index value and the second index value by evaluating whether a base size meets or exceeds a minimum threshold and whether stability constraints are satisfied. For regression-based validation, minimum panel sizes often include 3,000-5,000 or more total households in the category and 300-500 minimum households exposed to the attribute. A time structure of at least two periods (t and t+1), and ideally rolling 52 weeks, provides sufficient variation in attribute exposure and incremental purchase movement.

If the conditions at block 904 are not met (No branch), the example method 900 may include the systems described herein preventing the one or more processors from executing a monetization computation for the attribute and flagging the attribute as directional only in the output. In particular, when an attribute fails the stability and sample-size gate at block 904, the systems described herein may set a stability flag in a data structure associated with the attribute, wherein the stability flag causes downstream processing modules to bypass monetization computation, recommendation generation, and/or opportunity-state classification for that attribute. For example, if an attribute has fewer than 300 households exposed, the systems described herein set the stability flag to a value indicating insufficient sample size, and downstream processing modules check the stability flag before allocating processing resources to that attribute. When the stability flag indicates insufficient sample size, the system skips execution of the monetization computation module, which would otherwise perform multiplication operations across the attribute's index values, adoption rate assumptions, and spend values for each subset of users.

Additionally, or alternatively, the systems may interpret this flag and skip execution of any other subsequent processing operations. For example, the flag may be set in a manner that the systems described herein skip the recommendation generation module, which would otherwise invoke the opportunity-state classifier and generate output text or data objects for the attribute; and/or execution of regression validation operations for the attribute, which would otherwise perform matrix inversion, coefficient estimation, and standard error computation. By gating these downstream operations based on the stability flag, the system avoids allocating processor cycles, memory bandwidth, and storage operations to computations that would produce statistically unreliable outputs. As mentioned, this is particularly significant at scale. Namely, when the system processes hundreds of attributes across dozens of segments, a naive implementation that processes every attribute through the full computational pipeline regardless of sample adequacy would expend significant processing resources on regression fitting, interaction term computation, control variable adjustment, and monetization projection for attributes whose small sample sizes produce high-variance coefficient estimates and unreliable monetization figures. The stability and sample-size gate at block 904 thus operates as a computational triage mechanism that directs processing resources toward attributes with sufficient statistical foundation to produce reliable outputs, while conserving resources that would otherwise be consumed by computations on statistically unstable data.

However, when the conditions at block 904 are satisfied (Yes branch), the example method 900 proceeds to block 908, where the systems described herein apply a regression model to determine whether one or more of the plurality of attributes independently predict a future action value. As described herein, the regression model is a linear regression model, but it should be understood that any suitable regression technique may be applied. The linear regression algorithm uses attribute exposure at a first time period as a predictor variable, a category-level action value at a subsequent time period as an outcome variable, and one or more control variables comprising at least one of: price, promotion, baseline spend, and/or retailer mix. As previously mentioned, the regression model structure may be represented as:

$${Y}_{h h} = {β}_{0} + {β}_{1} \times {X}_{h h}^{OO} + {β}_{2} \times {X}_{h h}^{Baked} + {β}_{3} \times ( {X}_{h h}^{OO} \times {X}_{h h}^{Baked} ) + {γ}^{′} \times Controls + ε , \qquad ( 29 )$$

where Yₕₕ represents category spend for household hh at time t+1,

$${X}_{h h}^{OO}$$

represents olive oil attribute exposure for household hh at time t,

$${X}_{h h}^{Baked}$$

represents baked attribute exposure for household hh at time t, β₃ represents an interaction term representing a combination of two or more attributes, γ′ represents coefficients for control variables, and ε represents error terms with clustered standard errors at a household level. Attribute exposure variables may be defined as binary purchase indicators, spend share, or penetration in period t, with the definition being consistent across attributes. The outcome variable may be modeled as log (1+spend) to address right-skew in household spend distribution. Further, within the regression, the control variables may include price, promotion, baseline spend, retailer mix, and/or demographics, among others. For example, if β₁>0 and remains stable after including controls, the olive oil attribute demonstrates additive incremental value; if the effect disappears with controls, the attribute may function as a proxy for other factors; and if β₃>0, the interaction strengthens the platform effect.

Following block 908, the example method 900 proceeds to block 910, which generally represents a regression validation gate. In particular, the systems described herein determine whether the attribute independently predicts the future action value based on the regression output, including coefficient estimates, standard errors, confidence intervals, significance levels, model fit statistics, interaction terms, and robustness checks. If the attribute does not independently predict the future action value (No branch), the example method 900 proceeds to block 912, where the systems described herein suppress downstream computation of a monetization estimate and a recommendation for the attribute. For example, if the regression determines that the “olive oil” attribute coefficient is not statistically distinguishable from zero after controlling for price and baseline spend, the systems described herein suppress monetization computation for that attribute. Similar to the stability and sample-size gating, this monetization computation suppression for attributes that do not independently predict future action values allows the system to avoid allocating processing resources to subsequent processing steps (e.g., generating monetization projections, adoption rate calculations, and recommendation outputs) for attributes whose apparent gaps are attributable to confounding factors rather than genuine incremental demand. Consequently, the present systems direct computational resources toward attributes with validated predictive power.

However, if the attribute does independently predict the future action value at block 910 (Yes branch), the example method 900 proceeds to block 914, where the systems described herein permit the downstream computation of the monetization estimate and the recommendation for the attribute. The systems described herein may utilize regression in certain circumstances (e.g., an attribute overlaps heavily with other attributes, an attribute carries a price premium, and/or high financial stakes decisions are involved), but regression may generally not be used for large dominant attributes where the gap alone is sufficient for prioritization. In some cases, executing the index algorithm includes executing a machine learning (ML) model, and the systems described herein may predict, by the ML model, a future third index value for at least one of the groups of users based on the first set of index data and the second set of index data. Moreover, the systems described herein may further predict, by the ML model, a product recommendation based on the future third index value and cause the product recommendation to be displayed on the user interface.

In certain embodiments, the system outputs may be presented in various formats depending on the analytical context and user requirements. For example, the third index value, opportunity state, and saturation value may be presented as numerical scores, index values, rankings, flags, visualizations, signals, classifications, alerts, records, dashboard elements, and/or recommendations. The interpretation of these outputs may vary based on brand strategy, category dynamics, competitive context, and/or market conditions, and the systems described herein generally do not require that users interpret the outputs in any prescribed manner. Moreover, the systems described herein may generate outputs for consumption by human analysts, automated decisioning systems, downstream processing modules, external systems via application programming interfaces (APIs), and/or any suitable combinations thereof.

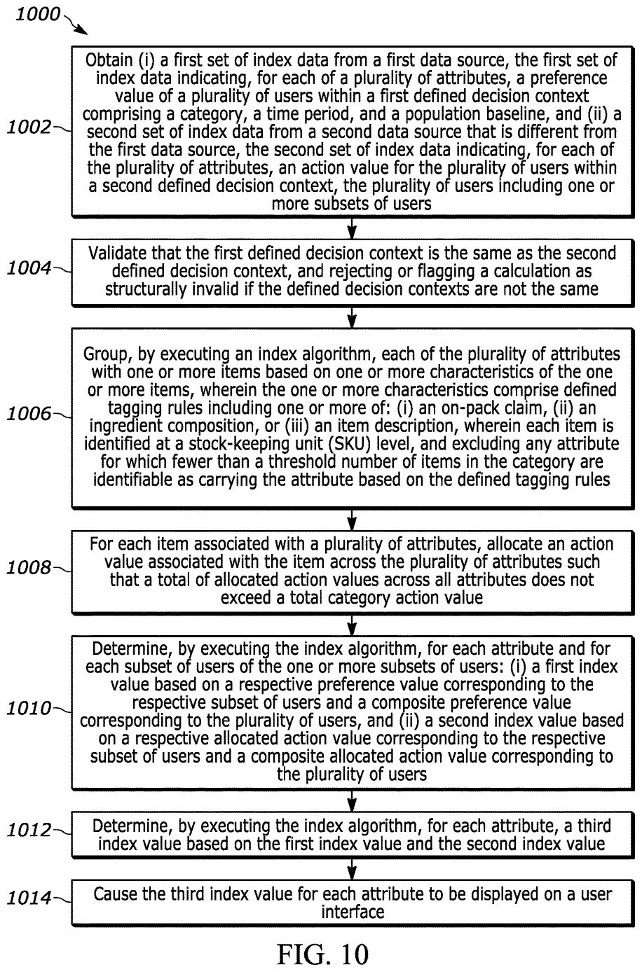

FIG. 10 is a flowchart of an example method 1000 for comparative index analysis involving decision context validation and attribute-based indexing, in accordance with embodiments described herein. The example method 1000 includes obtaining (i) a first set of index data from a first data source, the first set of index data indicating, for each of a plurality of attributes, a preference value of a plurality of users within a first defined decision context comprising a category, a time period, and a population baseline, and (ii) a second set of index data from a second data source that is different from the first data source (block 1002). The second set of index data may indicate, for each of the plurality of attributes, an action value for the plurality of users within a second defined decision context, and the plurality of users may include one or more subsets of users. The method 1000 further includes validating that the first defined decision context is the same as the second defined decision context, and rejecting or flagging a calculation as structurally invalid if the defined decision contexts are not the same (block 1004).

The example method 1000 may further include grouping, by executing an index algorithm, each of the plurality of attributes with one or more items based on one or more characteristics of the one or more items (block 1006). The one or more characteristics may comprise defined tagging rules including one or more of: (i) an on-pack claim, (ii) an ingredient composition, or (iii) an item description, and each item may be identified at a stock-keeping unit (SKU) level, and excluding any attribute for which fewer than a threshold number of items in the category are identifiable as carrying the attribute based on the defined tagging rules. The example method 1000 further includes, for each item associated with a plurality of attributes, allocating an action value associated with the item across the plurality of attributes such that a total of allocated action values across all attributes does not exceed a total category action value (block 1008).

The example method 1000 further includes determining, by executing the index algorithm, for each attribute and for each subset of users of the one or more subsets of users: (i) a first index value based on a respective preference value corresponding to the respective subset of users and a composite preference value corresponding to the plurality of users, and (ii) a second index value based on a respective allocated action value corresponding to the respective subset of users and a composite allocated action value corresponding to the plurality of users (block 1010). The method 1000 further includes determining, by executing the index algorithm, for each attribute, a third index value based on the first index value and the second index value (block 1012); and causing the third index value for each attribute to be displayed on a user interface (block 1014).

In certain embodiments, allocating the action value comprises dividing the action value for the item equally across a number k of attributes associated with the item.

In certain embodiments, the method 1000 further includes automatically verifying, by the one or more processors, that total allocated action values across all attributes equal a total category-level action value; and in response to determining that the total allocated action values do not equal the total category-level action value, preventing downstream computation of the first index value, the second index value, and the third index value until the total allocated action values are reconciled to the total category-level action value.

In certain embodiments, the method 1000 further includes grouping the plurality of attributes into a platform comprising a set of attributes; determining a composite first index value as an equal-weight average of the first index values across the set of attributes; and determining a composite second index value as a weighted sum of the second index values across the set of attributes, wherein each weight is based on a total population action value for the respective attribute relative to a sum of total population action values across all attributes in the set.

In certain embodiments, determining the composite second index value further comprises: determining, by the one or more processors, whether any weight exceeds a maximum threshold; in response to determining that a weight exceeds the maximum threshold, capping the weight at the maximum threshold and renormalizing the weights such that the weights sum to one, thereby preventing the composite second index value from becoming computationally dependent on a single attribute.

In certain embodiments, the method 1000 further includes determining a composite third index value based on the composite first index value and the composite second index value, wherein the composite third index value reflects opportunity adjusted for economic scale.

In certain embodiments, one or more weighting values applied to the first index values are determined based on conceptual importance; and one or more weighting values applied to the second index values are determined based on economic scale; wherein the weighting structures for the first index values and the second index values remain distinct and are not combined without explicit justification.

In certain embodiments, the method 1000 further includes executing, by the one or more processors, a linear regression algorithm to determine whether one or more of the plurality of attributes independently predict a future action value, wherein the linear regression algorithm uses: attribute exposure at a first time period as a predictor variable; a category-level action value at a subsequent time period as an outcome variable; and one or more control variables comprising at least one of: price, promotion, baseline spend, or retailer mix; in response to the linear regression algorithm determining that an attribute does not independently predict the future action value, suppressing downstream computation of a monetization estimate and a recommendation for the attribute; and in response to the linear regression algorithm determining that the attribute independently predicts the future action value, permitting the downstream computation of the monetization estimate and the recommendation for the attribute.

In certain embodiments, the linear regression algorithm further comprises: an interaction term representing a combination of two or more attributes; and clustered standard errors at a household level.

In certain embodiments, the method 1000 further includes determining, by the one or more processors, for each attribute, a saturation value representing at least an attribute exposure across a supercategory, wherein the saturation value is derived from action values associated with items carrying the attribute.

In certain embodiments, the method 1000 further includes classifying, by the one or more processors, each attribute into an opportunity state based on a combination of the first index value, the second index value, the third index value, and the saturation value; and selecting, by the one or more processors based on the opportunity state, a processing path from a plurality of different processing paths, wherein each processing path generates a different type of output for the attribute.

In certain embodiments, classifying each attribute into an opportunity state comprises applying a rule-based classification, wherein: an innovation opportunity is classified when the first index value exceeds a first threshold, the second index value is below a second threshold, and the saturation value is below a third threshold; a friction opportunity is classified when the first index value exceeds the first threshold, the second index value is below the second threshold, and the saturation value exceeds the third threshold; and an overinvestment signal is classified when the first index value is below the first threshold, the second index value exceeds the second threshold, and the saturation value exceeds the third threshold.

In certain embodiments, the method 1000 further includes generating, by the one or more processors, a recommendation based on the opportunity state, wherein the recommendation differs based on whether the opportunity state is an innovation opportunity, a friction opportunity, or an overinvestment signal.

In certain embodiments, determining the saturation value further comprises normalizing the saturation value within a supercategory using a z-score, and further comprising: identifying outlier attributes using a Herfindahl-based index applied to the saturation values within the supercategory.

In certain embodiments, the method 1000 further includes determining, by the one or more processors, an incremental dollar value based on a current spend value, an adoption rate, and the third index value, wherein the incremental dollar value represents scenario-based potential and the adoption rate incorporates one or more of: distribution feasibility, messaging impact, or supply constraints.

In certain embodiments, the method 1000 further includes defining a hierarchical relationship comprising: (i) consumer need states representing underlying motivations, (ii) product attributes representing features or claims that signal or deliver the consumer need states, and (iii) product executions representing observable products and formats; wherein the third index value is calculated at the attribute level, and the method further comprises determining whether a demand gap indicated by the third index value is driven by an unmet consumer need, an attribute-level misalignment, or a product execution performance issue.

In certain embodiments, the method 1000 further includes applying, by the one or more processors, minimum sample size thresholds and stability constraints to the first index value and the second index value; in response to determining that an attribute fails to meet the minimum sample size threshold, preventing the one or more processors from executing a monetization computation for the attribute and flagging the attribute as directional only in the output; and in response to determining that the attribute meets the minimum sample size threshold, permitting the one or more processors to execute the monetization computation for the attribute.

In certain embodiments, the method 1000 further includes generating a structured output comprising: attribute-level first, second, and third index values for each attribute and each subset of users; weighting tables; base sizes; stability indicators; and spend reconciliation data confirming that total allocated action values equal total category action values.

In certain embodiments, the system may optionally store or output audit and provenance metadata to support transparency and reproducibility. For example, such metadata may include decision context parameters (e.g., category, time period, population baseline), attribute-to-item mapping version, tagging rule version, allocation method identifier, weighting parameters, threshold values, reconciliation status, sample sizes, stability flags, data source identifiers, processing timestamps, model version identifiers, user-defined configuration parameters, and/or combinations thereof. It should be appreciated that the audit metadata is an optional system capability and is not required for every output. Moreover, the specific metadata fields included in any particular output may be configured based on user requirements, regulatory context, and/or analytical objectives.

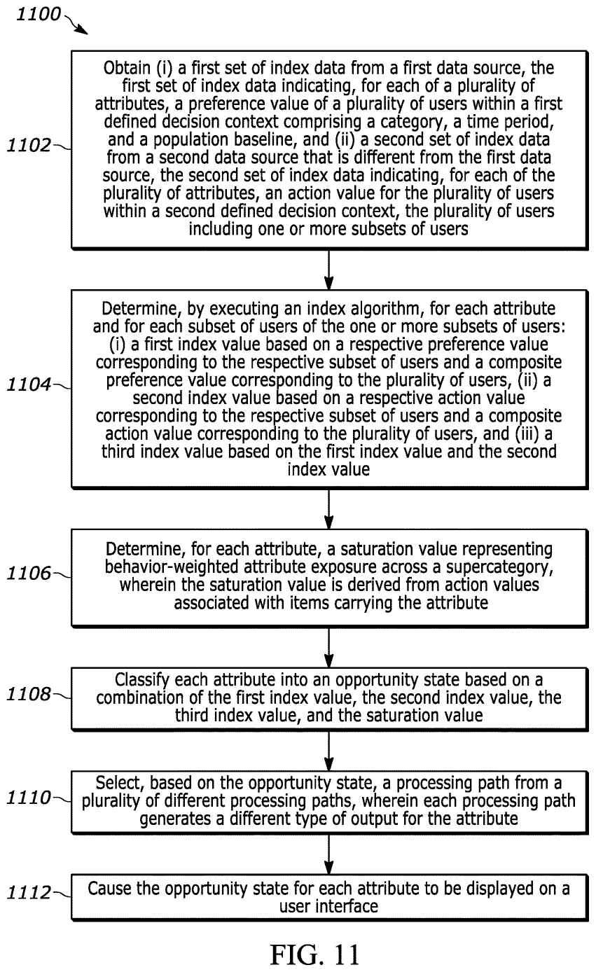

FIG. 11 is a flowchart of an example method 1100 for comparative index analysis incorporating saturation values and opportunity state classification, in accordance with embodiments described herein. The example method 1100 includes obtaining (i) a first set of index data from a first data source, the first set of index data indicating, for each of a plurality of attributes, a preference value of a plurality of users within a first defined decision context comprising a category, a time period, and a population baseline, and (ii) a second set of index data from a second data source that is different from the first data source (block 1102). The second set of index data may indicate, for each of the plurality of attributes, an action value for the plurality of users within a second defined decision context, and the plurality of users may include one or more subsets of users. The method 1100 further includes determining, by executing an index algorithm, for each attribute and for each subset of users of the one or more subsets of users: (i) a first index value based on a respective preference value corresponding to the respective subset of users and a composite preference value corresponding to the plurality of users, (ii) a second index value based on a respective action value corresponding to the respective subset of users and a composite action value corresponding to the plurality of users, and (iii) a third index value based on the first index value and the second index value (block 1104).

The example method 1100 further includes determining, for each attribute, a saturation value representing behavior-weighted attribute exposure across a supercategory (block 1106). The saturation value may generally be derived from action values associated with items carrying the attribute weighted by market footprint. The method 1100 further includes classifying each attribute into an opportunity state based on a combination of the first index value, the second index value, the third index value, and the saturation value (block 1108). The example method 1100 further includes selecting, based on the opportunity state, a processing path from a plurality of different processing paths, wherein each processing path generates a different type of output for the attribute (block 1110). The example method 1100 further includes causing the opportunity state for each attribute to be displayed on a user interface (block 1112).

In certain embodiments, classifying each attribute into an opportunity state comprises applying a rule-based classification, wherein: an innovation opportunity is classified when the first index value exceeds a first threshold, the second index value is below a second threshold, and the saturation value is below a third threshold; a friction opportunity is classified when the first index value exceeds the first threshold, the second index value is below the second threshold, and the saturation value exceeds the third threshold; and an overinvestment signal is classified when the first index value is below the first threshold, the second index value exceeds the second threshold, and the saturation value exceeds the third threshold.

In certain embodiments, the method 1100 further includes generating, by the one or more processors, a recommendation based on the opportunity state, wherein the recommendation differs based on whether the opportunity state is an innovation opportunity, a friction opportunity, or an overinvestment signal.

In certain embodiments, determining the saturation value further comprises normalizing the saturation value within a supercategory using a z-score, and further comprising: identifying outlier attributes using a Herfindahl-based index applied to the saturation values within the supercategory.

### ADDITIONAL CONSIDERATIONS

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for comparative index analysis, the method comprising:
obtaining, by one or more processors, (i) a first set of index data from a first data source, the first set of index data indicating, for each of a plurality of attributes, a preference value of a plurality of users within a first defined decision context comprising a category, a time period, and a population baseline, and (ii) a second set of index data from a second data source that is different from the first data source, the second set of index data indicating, for each of the plurality of attributes, an action value for the plurality of users within a second defined decision context, the plurality of users including one or more subsets of users;
validating, by the one or more processors, that the first defined decision context is the same as the second defined decision context, and rejecting or flagging a calculation as structurally invalid if the defined decision contexts are not the same;
grouping, by the one or more processors executing an index algorithm, each of the plurality of attributes with one or more items based on one or more characteristics of the one or more items, wherein the one or more characteristics comprise defined tagging rules including one or more of: (i) an on-pack claim, (ii) an ingredient composition, or (iii) an item description, wherein each item is identified at a stock-keeping unit (SKU) level, and excluding any attribute for which fewer than a threshold number of items in the category are identifiable as carrying the attribute based on the defined tagging rules;
for each item associated with a plurality of attributes, allocating, by the one or more processors, an action value associated with the item across the plurality of attributes such that a total of allocated action values across all attributes does not exceed a total category action value;
determining, by the one or more processors executing the index algorithm, for each attribute and for each subset of users of the one or more subsets of users: (i) a first index value based on a respective preference value corresponding to the respective subset of users and a composite preference value corresponding to the plurality of users, and (ii) a second index value based on a respective allocated action value corresponding to the respective subset of users and a composite allocated action value corresponding to the plurality of users;
determining, by the one or more processors executing the index algorithm, for each attribute, a third index value representing a discrepancy between stated user preferences and observed user actions, the third index value being based on the first index value and the second index value; and
causing, by the one or more processors, the third index value for each attribute to be displayed on a user interface.

2. The computer-implemented method of claim 1, wherein allocating the action value comprises dividing the action value for the item equally across a number k of attributes associated with the item.

3. The computer-implemented method of claim 1, further comprising:
verifying, by the one or more processors, that total allocated action values across all attributes equal a total category-level action value; and
in response to determining that the total allocated action values do not equal the total category-level action value, preventing, by the one or more processors modifying a data flag associated with the attributes, downstream computation of the first index value, the second index value, and the third index value until the total allocated action values are reconciled to the total category-level action value.

4. The computer-implemented method of claim 1, further comprising:
grouping, by the one or more processors, the plurality of attributes into a platform comprising a set of attributes;
determining, by the one or more processors, a composite first index value as an equal-weight average of the first index values across the set of attributes; and
determining, by the one or more processors, a composite second index value as a weighted sum of the second index values across the set of attributes, wherein each weight is based on a total population action value for the respective attribute relative to a sum of total population action values across all attributes in the set.

5. The computer-implemented method of claim 4, wherein determining the composite second index value further comprises:
determining, by the one or more processors, whether any weight exceeds a maximum threshold; and
in response to determining that a weight exceeds the maximum threshold, capping, by the one or more processors, the weight at the maximum threshold and renormalizing the weights such that the weights sum to one, thereby preventing the composite second index value from becoming computationally dependent on a single attribute.

6. The computer-implemented method of claim 4, further comprising:
determining, by the one or more processors, a composite third index value based on the composite first index value and the composite second index value, wherein the composite third index value reflects opportunity adjusted for economic scale.

7. The computer-implemented method of claim 1, further comprising:
determining, by the one or more processors, one or more weighting values applied to the first index values based on conceptual importance;
determining, by the one or more processors, one or more weighting values applied to the second index values based on economic scale; and
wherein the one or more weighting values for the first index values and the second index values remain distinct and are not combined without explicit justification.

8. The computer-implemented method of claim 1, further comprising:
executing, by the one or more processors, a linear regression algorithm to determine whether one or more of the plurality of attributes independently predict a future action value, wherein the linear regression algorithm uses:
attribute exposure at a first time period as a predictor variable;
a category-level action value at a subsequent time period as an outcome variable; and
one or more control variables comprising at least one of: price, promotion, baseline spend, or retailer mix;
in response to the linear regression algorithm determining that an attribute does not independently predict the future action value, suppressing, by the one or more processors, downstream computation of a monetization estimate and a recommendation for the attribute; and
in response to the linear regression algorithm determining that the attribute independently predicts the future action value, permitting, by the one or more processors, the downstream computation of the monetization estimate and the recommendation for the attribute.

9. The computer-implemented method of claim 1, further comprising:
determining, by the one or more processors, for each attribute, a saturation value representing at least an attribute exposure across a supercategory, wherein the saturation value is derived from action values associated with items carrying the attribute.

10. The computer-implemented method of claim 9, further comprising:
classifying, by the one or more processors, each attribute into an opportunity state based on a combination of the first index value, the second index value, the third index value, and the saturation value; and
selecting, by the one or more processors based on the opportunity state, a processing path from a plurality of different processing paths, wherein each processing path generates a different type of output for the attribute.

11. The computer-implemented method of claim 10, wherein classifying each attribute into an opportunity state comprises applying a rule-based classification that comprises:
classifying, by the one or more processors, a first attribute as an innovation opportunity when the first index value exceeds a first threshold, the second index value is below a second threshold, and the saturation value is below a third threshold;
classifying, by the one or more processors, the first attribute as a friction opportunity when the first index value exceeds the first threshold, the second index value is below the second threshold, and the saturation value exceeds the third threshold; and
classifying, by the one or more processors, the first attribute as an overinvestment signal when the first index value is below the first threshold, the second index value exceeds the second threshold, and the saturation value exceeds the third threshold.

12. The computer-implemented method of claim 10, further comprising:
generating, by the one or more processors, a recommendation based on the opportunity state, wherein the recommendation differs based on whether the opportunity state is an innovation opportunity, a friction opportunity, or an overinvestment signal.

13. The computer-implemented method of claim 9, wherein determining the saturation value further comprises normalizing the saturation value within a supercategory using a z-score, and further comprising:
determining, by the one or more processors, outlier attributes using a Herfindahl-based index applied to the saturation values within the supercategory; and
performing, by the one or more processors, at least one of (i) flagging, (ii) down-weighting, (iii) routing to a separate processing path, (iv) suppressing from a monetization computation, or (v) excluding from one or more downstream outputs, the outlier attributes.

14. The computer-implemented method of claim 1, further comprising:
determining, by the one or more processors, an incremental dollar value based on a current spend value, an adoption rate, and the third index value, wherein the incremental dollar value represents scenario-based potential and the adoption rate incorporates one or more of: distribution feasibility, messaging impact, or supply constraints.

15. The computer-implemented method of claim 1, further comprising:
defining, by the one or more processors, a hierarchical relationship comprising: (i) consumer need states representing underlying motivations, (ii) product attributes representing features or claims that signal or deliver the consumer need states, and (iii) product executions representing observable products and formats; and
wherein the third index value is calculated at the attribute level, and the method further comprises determining, by the one or more processors, whether a demand gap indicated by the third index value is driven by an unmet consumer need, an attribute-level misalignment, or a product execution performance issue.

16. The computer-implemented method of claim 1, further comprising:
applying, by the one or more processors, minimum sample size thresholds and stability constraints to the first index value and the second index value;
in response to determining that an attribute fails to meet the minimum sample size threshold, preventing, by the one or more processors, execution of a monetization computation for the attribute and flagging the attribute as directional only; and
in response to determining that the attribute meets the minimum sample size threshold, permitting, by the one or more processors, execution of the monetization computation for the attribute.

17. A system for comparative index analysis, the system comprising:
one or more processors; and
one or more memories storing processor-executable instructions that, when executed by the one or more processors, cause the one or more processors to perform operations comprising:
obtaining (i) a first set of index data from a first data source, the first set of index data indicating, for each of a plurality of attributes, a preference value of a plurality of users within a first defined decision context comprising a category, a time period, and a population baseline, and (ii) a second set of index data from a second data source that is different from the first data source, the second set of index data indicating, for each of the plurality of attributes, an action value for the plurality of users within a second defined decision context, the plurality of users including one or more subsets of users;
validating that the first defined decision context is the same as the second defined decision context, and rejecting or flagging a calculation as structurally invalid if the defined decision contexts are not the same;
grouping, by an index algorithm, each of the plurality of attributes with one or more items based on one or more characteristics of the one or more items, wherein the one or more characteristics comprise defined tagging rules including one or more of: (i) an on-pack claim, (ii) an ingredient composition, or (iii) an item description, wherein each item is identified at a stock-keeping unit (SKU) level, and excluding any attribute for which fewer than a threshold number of items in the category are identifiable as carrying the attribute based on the defined tagging rules;
for each item associated with a plurality of attributes, allocating an action value associated with the item across the plurality of attributes such that a total of allocated action values across all attributes does not exceed a total category action value;
determining, by the index algorithm for each attribute and for each subset of users of one or more subsets of users, (i) a first index value based on a respective preference value corresponding to a respective subset of users and a composite preference value corresponding to a plurality of users, and (ii) a second index value based on a respective allocated action value corresponding to the respective subset of users and a composite allocated action value corresponding to the plurality of users;
determining, by the index algorithm, for each attribute, a third index value representing a discrepancy between stated user preferences and observed user actions, the third index value being based on the first index value and the second index value; and
causing the third index value for each attribute to be displayed on a user interface.

18. One or more non-transitory computer-readable media storing processor-executable instructions that, when executed by one or more processors, cause the one or more processors to perform operations comprising:
obtaining (i) a first set of index data from a first data source, the first set of index data indicating, for each of a plurality of attributes, a preference value of a plurality of users within a first defined decision context comprising a category, a time period, and a population baseline, and (ii) a second set of index data from a second data source that is different from the first data source, the second set of index data indicating, for each of the plurality of attributes, an action value for the plurality of users within a second defined decision context, the plurality of users including one or more subsets of users;
validating that the first defined decision context is the same as the second defined decision context, and rejecting or flagging a calculation as structurally invalid if the defined decision contexts are not the same;
grouping, by an index algorithm, each of the plurality of attributes with one or more items based on one or more characteristics of the one or more items, wherein the one or more characteristics comprise defined tagging rules including one or more of: (i) an on-pack claim, (ii) an ingredient composition, or (iii) an item description, wherein each item is identified at a stock-keeping unit (SKU) level, and excluding any attribute for which fewer than a threshold number of items in the category are identifiable as carrying the attribute based on the defined tagging rules;
for each item associated with a plurality of attributes, allocating an action value associated with the item across the plurality of attributes such that total allocated action values do not exceed a total category action value;
determining, by the index algorithm for each attribute and for each subset of users of one or more subsets of users, (i) a first index value based on a respective preference value corresponding to a respective subset of users and a composite preference value corresponding to the plurality of users, and (ii) a second index value based on a respective allocated action value corresponding to the respective subset of users and a composite allocated action value corresponding to the plurality of users;
determining, by the index algorithm, for each attribute, a third index value representing a discrepancy between stated user preferences and observed user actions, the third index value being based on the first index value and the second index value; and
causing the third index value for each attribute to be displayed on a user interface.

19. A computer-implemented method for classifying market opportunities, the method comprising:
obtaining, by one or more processors, (i) a first set of index data from a first data source, the first set of index data indicating, for each of a plurality of attributes, a preference value of a plurality of users within a first defined decision context comprising a category, a time period, and a population baseline, and (ii) a second set of index data from a second data source that is different from the first data source, the second set of index data indicating, for each of the plurality of attributes, an action value for the plurality of users within a second defined decision context, the plurality of users including one or more subsets of users;
determining, by the one or more processors executing an index algorithm, for each attribute and for each subset of users of the one or more subsets of users: (i) a first index value based on a respective preference value corresponding to the respective subset of users and a composite preference value corresponding to the plurality of users, (ii) a second index value based on a respective action value corresponding to the respective subset of users and a composite action value corresponding to the plurality of users, and (iii) a third index value representing a discrepancy between stated user preferences and observed user actions, the third index value being based on the first index value and the second index value;
determining, by the one or more processors, for each attribute, a saturation value representing at least an attribute exposure across a supercategory, wherein the saturation value is derived from action values associated with items carrying the attribute;
classifying, by the one or more processors, each attribute into an opportunity state based on a combination of the first index value, the second index value, the third index value, and the saturation value;
selecting, by the one or more processors based on the opportunity state, a processing path from a plurality of different processing paths, wherein each processing path generates a different type of output for the attribute; and
causing, by the one or more processors, the opportunity state for each attribute to be displayed on a user interface.

20. The computer-implemented method of claim 19, wherein classifying each attribute into an opportunity state comprises applying a rule-based classification that comprises:
classifying, by the one or more processors, a first attribute as an innovation opportunity when the first index value exceeds a first threshold, the second index value is below a second threshold, and the saturation value is below a third threshold;
classifying, by the one or more processors, the first attribute as a friction opportunity when the first index value exceeds the first threshold, the second index value is below the second threshold, and the saturation value exceeds the third threshold; and
classifying, by the one or more processors, the first attribute as an overinvestment signal when the first index value is below the first threshold, the second index value exceeds the second threshold, and the saturation value exceeds the third threshold.
